(19) United States
(12) Patent Application Publication
(10) Pub. No.: US 2025/0323764 A1
(43) Pub. Date: Oct. 16, 2025

(54) UPLINK RESOURCE MUTING FOR VARIOUS WAVEFORMS

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Peter GAAL, San Diego, CA (US); Jae Ho RYU, San Diego, CA (US)

(21) Appl. No.: 18/972,507

(22) Filed: Dec. 6, 2024

Related U.S. Application Data
(60) Provisional application No. 63/634,312, filed on Apr. 15, 2024.

(51) Int. Cl. H04L 5/00; H04L 27/26; H04W 72/21

(52) U.S. Cl. CPC H04L 5/0005; H04L 5/0048; H04L 27/2636; H04W 72/21

(57) ABSTRACT

Methods, systems, and devices for wireless communications are described. A user equipment (UE) may transmit uplink signaling via a cyclic prefix orthogonal frequency division multiplexing (CP-OFDM) waveform or a discrete Fourier transform (DFT) spread OFDM (DFT-s-OFDM) waveform. A configured resource muting pattern may be based on or may reuse a phase tracking reference signal (PTRS) frequency pattern. The resource muting pattern may mute every other resource element (RE) of an uplink symbol or uplink subband of subband full duplex (SBFD) symbols, and the transmitting UE may perform uplink rate matching (e.g., applying a zero power PTRS pattern and inserting the zero power REs after a DFT spread operation, oversampling after a DFT-s-OFDM procedure and doubling a size of an IFFT, or repeating an input sequence to a DFT and doubling a size of the IFFT, power boosting, updating a power control calculation, etc.).

### CROSS REFERENCE

The present Application for Patent claims the benefit of U.S. Provisional Patent Application No. 63/634,312 by Zhang et al., entitled “UPLINK MUTING FOR VARIOUS WAVEFORMS,” filed Apr. 15, 2024, assigned to the assignee hereof, and expressly incorporated by reference herein.

### FIELD OF TECHNOLOGY

The following relates to wireless communications, including uplink resource muting for various waveforms.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a resource muting pattern indicating a first set of multiple uplink time and frequency resources for muting uplink transmissions via an uplink channel, refraining from performing at least uplink data channel transmissions via the first set of multiple uplink time and frequency resources via the uplink channel according to the resource muting pattern, and transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

A UE for wireless communications is described. The UE may include one or more memories storing processor executable code, and one or more processors coupled with the one or more memories. The one or more processors may individually or collectively be operable to execute the code to cause the UE to receive control signaling indicating a resource muting pattern indicating a first set of multiple uplink time and frequency resources for muting uplink transmissions via an uplink channel, refrain from performing at least uplink data channel transmissions via the first set of multiple uplink time and frequency resources via the uplink channel according to the resource muting pattern, and transmit at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

Another UE for wireless communications is described. The UE may include means for receiving control signaling indicating a resource muting pattern indicating a first set of multiple uplink time and frequency resources for muting uplink transmissions via an uplink channel, means for refraining from performing at least uplink data channel transmissions via the first set of multiple uplink time and frequency resources via the uplink channel according to the resource muting pattern, and means for transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

A non-transitory computer-readable medium storing code for wireless communications is described. The code may include instructions executable by one or more processors to receive control signaling indicating a resource muting pattern indicating a first set of multiple uplink time and frequency resources for muting uplink transmissions via an uplink channel, refrain from performing at least uplink data channel transmissions via the first set of multiple uplink time and frequency resources via the uplink channel according to the resource muting pattern, and transmit at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

In some examples of the method, UEs, and non-transitory computer-readable medium described herein, the resource muting pattern includes an indication of a first quantity of frequency tones for muting in each set of a second quantity of resource blocks of a set of multiple resource blocks, and where and refraining from performing at least uplink data channel transmission via the first set of multiple uplink time and frequency resources includes refraining from transmitting via the indicated quantity of frequency tones in each set of the second quantity of resource blocks of the set of multiple resource blocks.

In some examples of the method, UEs, and non-transitory computer-readable medium described herein, the resource muting pattern includes an indication of a first quantity of symbols for muting in each set of a second quantity of slots of a set of multiple slots, and where and refraining from performing at least uplink data channel transmission via the first set of multiple uplink time and frequency resources includes refraining from transmitting via the indicated quantity of symbols in each set of the second quantity of slots of the set of multiple slots.

In some examples of the method, UEs, and non-transitory computer-readable medium described herein, the resource muting pattern includes an indication of a first quantity of physical uplink shared channel symbols for muting in each set of a second quantity of physical uplink shared channel symbols, and where and refraining from performing at least uplink data channel transmission via the first set of multiple uplink time and frequency resources includes refraining from transmitting via the indicated first quantity of physical uplink shared channel symbols in each set of the second quantity of physical uplink shared channel symbols.

Some examples of the method, UEs, and non-transitory computer-readable medium described herein may further include operations, features, means, or instructions for receiving second control signaling indicating a second set of multiple time and frequency resources for phase tracking reference signal transmission, where the first set of multiple uplink time and frequency resources partially overlap with the second set of multiple time and frequency resources, completely overlap with at least a portion of the second set of multiple time and frequency resources, or do not overlap with the second set of multiple time and frequency resources, where the first set of multiple time and frequency resources include zero-power phase tracking reference signal resources of the zero-power phase tracking reference signal configuration.

In some examples of the method, UEs, and non-transitory computer-readable medium described herein, the resource muting pattern includes an indication of a first quantity of symbols including a subset of frequency resources of the second set of multiple time and frequency resources, where the frequency resources of the first set of multiple time and frequency resources may be the same as the frequency resources of the second set of multiple time and frequency resources, and where the time resources of the first set of multiple time and frequency resources include the first quantity of symbols, and where and refraining from at least uplink data channel transmission via the first set of multiple uplink time and frequency resources includes refraining from transmitting via the indicated first quantity of symbols.

In some examples of the method, UEs, and non-transitory computer-readable medium described herein, the resource muting pattern includes an indication of a first portion of the frequency resources of the second set of multiple time and frequency resources, where the frequency resources of the first set of multiple time and frequency resources may be the same as the frequency resources of the second set of multiple time and frequency resources, and where the time resources of the first set of multiple time and frequency resources include the first portion of the frequency resources of the second set of multiple time and frequency resources, and where and refraining from at least uplink data channel transmission via the first set of multiple uplink time and frequency resources includes refraining from transmitting via the indicated first portion of the second set of multiple time and frequency resources.

In some examples of the method, UEs, and non-transitory computer-readable medium described herein, the frequency resources of the first set of multiple uplink time and frequency resources overlap with the frequency resources of the second set of multiple uplink time and frequency resources and the time resources of the first set of multiple uplink time and frequency resources do not overlap with the second set of multiple time and frequency resources.

In some examples of the method, UEs, and non-transitory computer-readable medium described herein, the resource muting pattern includes an indication of an offset in time from the time resources of the second set of multiple uplink time and frequency resources, an offset in frequency from the frequency resources of the second set of multiple uplink time and frequency resources, or a combination thereof and the first set of multiple uplink time and frequency resources may be shifted from the second set of multiple uplink time and frequency resources according to the offset in time, the offset in frequency, or both.

In some examples of the method, UEs, and non-transitory computer-readable medium described herein, the resource muting pattern includes a comb muting pattern indicating the first set of multiple uplink time and frequency resources including one resource element occurring in one of every two resource elements of a set of multiple resource elements, and where and refraining from performing at least uplink data channel transmission via the first set of multiple uplink time and frequency resources includes refraining from transmitting via the indicated one in every two resource elements.

Some examples of the method, UEs, and non-transitory computer-readable medium described herein may further include operations, features, means, or instructions for performing a discrete Fourier transform spread procedure corresponding to the set of multiple resource elements and applying, subsequent to the discrete Fourier transform spread procedure, the zero-power phase tracking reference signal pattern configuration to each of the first set of multiple uplink time and frequency resources, where the at least uplink data channel signaling includes a discrete Fourier transform spread orthogonal frequency division multiplexing (DFT-s-OFDM) waveform.

Some examples of the method, UEs, and non-transitory computer-readable medium described herein may further include operations, features, means, or instructions for performing an oversampling procedure according to a factor of two on an output of the discrete Fourier transform spread procedure and performing an inverse fast Fourier transform on an output of the oversampling procedure with a double size of inverse fast Fourier transform, where the inverse fast Fourier transform size may be based on the comb muting pattern indicating the first set of multiple uplink time and frequency resources including one resource element occurring in one of every two resource elements of the set of multiple resource elements.

In some examples of the method, UEs, and non-transitory computer-readable medium described herein, the factor of two, the inverse fast Fourier transform size, or both, may be included in the one or more transmission parameters.

Some examples of the method, UEs, and non-transitory computer-readable medium described herein may further include operations, features, means, or instructions for duplicating a set of input values for the discrete Fourier transform spread procedure, the set of input values corresponding to the one or more uplink resources, inputting the set of input values and the duplicate set of input values into the discrete Fourier transform spread procedure, and performing an inverse fast Fourier transform on an output of the discrete Fourier transform spread procedure with a double size of inverse fast Fourier transform, where the inverse fast Fourier transform size may be based on the comb muting pattern indicating the first set of multiple uplink time and frequency resources including one resource element occurring in one of every two resource elements of the set of multiple resource elements.

In some examples of the method, UEs, and non-transitory computer-readable medium described herein, an instruction to duplicate the set of input values, the inverse fast Fourier transform size, or both, may be included in the one or more transmission parameters.

In some examples of the method, UEs, and non-transitory computer-readable medium described herein, the resource muting pattern mutes every other resource element of the set of multiple resource elements, and includes an instruction to mute a first quantity of symbols in each slot of a set of multiple slots, and where and refraining from performing at least uplink data channel transmission via the first set of multiple uplink time and frequency resources includes refraining from transmitting via the indicated first quantity of symbols in the set of multiple symbols.

In some examples of the method, UEs, and non-transitory computer-readable medium described herein, the one or more transmission parameters include a power boost value for the transmission power of the uplink channel overlapping with the first set of multiple uplink time and frequency resources.

Some examples of the method, UEs, and non-transitory computer-readable medium described herein may further include operations, features, means, or instructions for calculating a power control for the uplink channel across a set of ports at the UE according to a scaling factor corresponding to the set of ports and a transmitted precoding matrix indicator, where the one or more transmission parameters include the power control, scaling factor, the transmitted precoding matrix indicator, or any combination thereof, where transmitting the at least uplink data channel signaling includes transmitting via the uplink channels corresponding to the muting pattern, and where the power boost value corresponds to a 3 decibel increase in energy per resource element (EPRE) of the uplink channel.

Some examples of the method, UEs and non-transitory computer-readable medium described herein may further include operations, features, means, or instructions for calculating a power control for the uplink channel across a set of ports at the UE based on excluding the first set of multiple uplink time and frequency resources of the uplink channel, where the one or more transmission parameters include the power control.

In some examples of the method, UEs, and non-transitory computer-readable medium described herein, receiving the control signaling may include operations, features, means, or instructions for receiving radio resource control signaling indicating a set of multiple candidate resource muting patterns including the resource muting pattern and receiving a downlink control information message indicating the resource muting pattern and the one or more transmission parameters including one or more rate matching parameters for transmitting the at least uplink data channel signaling.

In some examples of the method, UEs, and non-transitory computer-readable medium described herein, receiving the control signaling may include operations, features, means, or instructions for receiving radio resource control signaling including a semi-static configuration of the resource muting pattern, the semi-static configuration including the one or more transmission parameters including one or more rate matching parameters for transmitting the at least uplink data channel signaling, a periodicity for the resource muting pattern, or a combination thereof.

In some examples of the method, UEs, and non-transitory computer-readable medium described herein, the first set of multiple uplink time and frequency resources may be unavailable for uplink data transmission or uplink control information.

In some examples of the method, UEs, and non-transitory computer-readable medium described herein, the first set of multiple uplink time and frequency resources do not overlap with a third set of multiple time and frequency resources allocated for uplink demodulation reference signals.

Some examples of the method, UEs, and non-transitory computer-readable medium described herein may further include operations, features, means, or instructions for determining whether to transmit a phase tracking reference signal via a first resource of the first set of multiple uplink time and frequency resources that overlaps with a phase tracking reference signal resource according to one or more rules.

Some examples of the method, UEs, and non-transitory computer-readable medium described herein may further include operations, features, means, or instructions for transmitting capability information indicating that the UE may be capable of muting uplink resources for a set of multiple waveforms, where receiving the control signaling indicating the resource muting pattern may be based on transmitting the capability information, and where the at least uplink data channel signaling includes one of the set of multiple waveforms.

Some examples of the method, UEs, and non-transitory computer-readable medium described herein may further include operations, features, means, or instructions for transmitting capability information indicating whether the UE may be capable of muting uplink resources for each respective waveform of a set of multiple waveforms, where receiving the control signaling indicating the resource muting pattern may be based on transmitting the capability information, and where the at least uplink data channel signaling includes one of the set of multiple waveforms.

In some examples of the method, UEs, and non-transitory computer-readable medium described herein, the at least uplink data channel signaling includes a cyclic prefix-orthogonal frequency division multiplexing (CP-OFDM) waveform, or a DFT-s-OFDM waveform.

A method for wireless communications by a network entity is described. The method may include outputting control signaling indicating a resource muting pattern indicating a first set of multiple uplink time and frequency resources for muting, by a UE, uplink transmissions via an uplink channel and obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

A network entity for wireless communications is described. The network entity may include one or more memories storing processor executable code, and one or more processors coupled with the one or more memories. The one or more processors may individually or collectively be operable to execute the code to cause the network entity to output control signaling indicating a resource muting pattern indicating a first set of multiple uplink time and frequency resources for muting, by a UE, uplink transmissions via an uplink channel and obtain at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

Another network entity for wireless communications is described. The network entity may include means for outputting control signaling indicating a resource muting pattern indicating a first set of multiple uplink time and frequency resources for muting, by a UE, uplink transmissions via an uplink channel and means for obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

A non-transitory computer-readable medium storing code for wireless communications is described. The code may include instructions executable by one or more processors to output control signaling indicating a resource muting pattern indicating a first set of multiple uplink time and frequency resources for muting, by a UE, uplink transmissions via an uplink channel and obtain at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

In some examples of the method, network entities, and non-transitory computer-readable medium described herein, the resource muting pattern includes an indication of a first quantity of frequency tones for muting in each set of a second quantity of resource blocks of a set of multiple resource blocks.

In some examples of the method, network entities, and non-transitory computer-readable medium described herein, the resource muting pattern includes an indication of a first quantity of symbols for muting in each set of a second quantity of slots of a set of multiple slots.

In some examples of the method, network entities, and non-transitory computer-readable medium described herein, the resource muting pattern includes an indication of a first quantity of physical uplink shared channel symbols for muting in each set of a second quantity of physical uplink shared channel symbols.

Some examples of the method, network entities, and non-transitory computer-readable medium described herein may further include operations, features, means, or instructions for outputting second control signaling indicating a second set of multiple time and frequency resources for phase tracking reference signal transmission, where the first set of multiple uplink time and frequency resources partially overlap with the second set of multiple time and frequency resources, completely overlap with at least a portion of the second set of multiple time and frequency resources, or do not overlap with the second set of multiple time and frequency resources, where the first set of multiple time and frequency resources include zero-power phase tracking reference signal resources of the zero-power phase tracking reference signal configuration.

In some examples of the method, network entities, and non-transitory computer-readable medium described herein, the resource muting pattern includes an indication of a first quantity of symbols including a subset of frequency resources of the second set of multiple time and frequency resources, the frequency resources of the first set of multiple time and frequency resources may be the same as the frequency resources of the second set of multiple time and frequency resources, and the time resources of the first set of multiple time and frequency resources include the first quantity of symbols.

In some examples of the method, network entities, and non-transitory computer-readable medium described herein, the resource muting pattern includes an indication of a first portion of the frequency resources of the second set of multiple time and frequency resources, the frequency resources of the first set of multiple time and frequency resources may be the same as the frequency resources of the second set of multiple time and frequency resources, and the time resources of the first set of multiple time and frequency resources include the first portion of the frequency resources of the second set of multiple time and frequency resources.

In some examples of the method, network entities, and non-transitory computer-readable medium described herein, the frequency resources of the first set of multiple uplink time and frequency resources overlap with the frequency resources of the second set of multiple uplink time and frequency resources and the time resources of the first set of multiple uplink time and frequency resources do not overlap with the second set of multiple time and frequency resources.

In some examples of the method, network entities, and non-transitory computer-readable medium described herein, the resource muting pattern includes an indication of an offset in time from the time resources of the second set of multiple uplink time and frequency resources, an offset in frequency from the frequency resources of the second set of multiple uplink time and frequency resources, or a combination thereof and the first set of multiple uplink time and frequency resources may be shifted from the second set of multiple uplink time and frequency resources according to the offset in time, the offset in frequency, or both.

In some examples of the method, network entities, and non-transitory computer-readable medium described herein, the resource muting pattern includes a comb muting pattern indicating the first set of multiple uplink time and frequency resources including one resource element occurring in one of every two resource elements of a set of multiple resource elements.

In some examples of the method, network entities, and non-transitory computer-readable medium described herein, the resource muting pattern mutes every other resource element of the set of multiple resource elements, and includes an instruction to mute a first quantity of symbols in each slot of a set of multiple slots.

In some examples of the method, network entities, and non-transitory computer-readable medium described herein, the one or more transmission parameters include a power boost value for the transmission power of the uplink channel overlapping with the first set of multiple uplink time and frequency resources.

In some examples of the method, network entities, and non-transitory computer-readable medium described herein, outputting the control signaling may include operations, features, means, or instructions for outputting radio resource control signaling indicating a set of multiple candidate resource muting patterns including the resource muting pattern and outputting a downlink control information message indicating the resource muting pattern and the one or more transmission parameters including one or more rate matching parameters for outputting the at least uplink data channel signaling.

In some examples of the method, network entities, and non-transitory computer-readable medium described herein, outputting the control signaling may include operations, features, means, or instructions for outputting radio resource control signaling including a semi-static configuration of the resource muting pattern, the semi-static configuration including the one or more transmission parameters including one or more rate matching parameters for outputting the at least uplink data channel signaling, a periodicity for the resource muting pattern, or a combination thereof.

In some examples of the method, network entities, and non-transitory computer-readable medium described herein, the first set of multiple uplink time and frequency resources may be unavailable for uplink data transmission or uplink control information.

In some examples of the method, network entities, and non-transitory computer-readable medium described herein, the first set of multiple uplink time and frequency resources do not overlap with a third set of multiple time and frequency resources allocated for uplink demodulation reference signals.

Some examples of the method, network entities, and non-transitory computer-readable medium described herein may further include operations, features, means, or instructions for obtaining capability information indicating that the UE may be capable of muting uplink resources for a set of multiple waveforms, where obtaining the control signaling indicating the resource muting pattern may be based on obtaining the capability information, and where the at least uplink data channel signaling includes one of the set of multiple waveforms.

Some examples of the method, network entities, and non-transitory computer-readable medium described herein may further include operations, features, means, or instructions for obtaining capability information indicating whether the UE may be capable of muting uplink resources for each respective waveform of a set of multiple waveforms, where outputting the control signaling indicating the resource muting pattern may be based on obtaining the capability information, and where the at least uplink data channel signaling includes one of the set of multiple waveforms.

In some examples of the method, network entities, and non-transitory computer-readable medium described herein, the at least uplink data channel signaling includes a cyclic prefix-orthogonal frequency division multiplexing (CP-OFDM) waveform, or a DFT-s-OFDM waveform.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports uplink resource muting for various waveforms in accordance with one or more aspects of the present disclosure.

FIG. 2 shows an example of a wireless communications system that supports uplink resource muting for various waveforms in accordance with one or more aspects of the present disclosure.

FIG. 3 shows an example of a resource muting scheme that supports uplink resource muting for various waveforms in accordance with one or more aspects of the present disclosure.

FIG. 4 shows an example of a transmission scheme that supports uplink resource muting for various waveforms in accordance with one or more aspects of the present disclosure.

FIG. 5 shows an example of a process flow that supports uplink resource muting for various waveforms in accordance with one or more aspects of the present disclosure.

FIGS. 6 and 7 show block diagrams of devices that support uplink resource muting for various waveforms in accordance with one or more aspects of the present disclosure.

FIG. 8 shows a block diagram of a communications manager that supports uplink resource muting for various waveforms in accordance with one or more aspects of the present disclosure.

FIG. 9 shows a diagram of a system including a device that supports uplink resource muting for various waveforms in accordance with one or more aspects of the present disclosure.

FIGS. 10 and 11 show block diagrams of devices that support uplink resource muting for various waveforms in accordance with one or more aspects of the present disclosure.

FIG. 12 shows a block diagram of a communications manager that supports uplink resource muting for various waveforms in accordance with one or more aspects of the present disclosure.

FIG. 13 shows a diagram of a system including a device that supports uplink resource muting for various waveforms in accordance with one or more aspects of the present disclosure.

FIGS. 14 through 17 show flowcharts illustrating methods that support uplink resource muting for various waveforms in accordance with one or more aspects of the present disclosure.

### DETAILED DESCRIPTION

In some examples, a wireless communications system may support one or more duplex modes (e.g., half duplex, full duplex, subband full duplex, among other examples). Devices operating in a full duplex mode may generate or experience cross-link interference (CLI). Such CLI may include CLI between user equipment (UEs) (e.g., intra-cell CLI, inter-cell CLI), and interference between network entities (inter-network entity CLI). In some examples, wireless devices may perform CLI measurements to detect and mitigate CLI (e.g., one network entity may perform CLI measurements to detect inter-network entity CLI from another network entity). However, if other devices (e.g., UEs) are transmitting during such CLI measurements, then sch CLI measurements may fail, or may be inaccurate, resulting in less effective or ineffective CLI mitigation, poor channel performance, failed transmissions, decreased reliability of wireless signaling, increased system latency, and decreased user experience. To address such CLI measurements, the network may configure one or more UEs to remain silent during some resources (e.g., resource muting). However, such resource muting may negatively impact uplink transmission via non-muted resources.

Techniques described herein provide for resource muting pattens that minimize the need for adjusted transmission parameters or rate matching due to muted resources, uplink transmission procedures and techniques to address rate matching and power control aspects resulting from muted resources, or a combination thereof. For example, a UE may transmit uplink signaling via a cyclic prefix orthogonal frequency division multiplexing (CP-OFDM) waveform. In such examples, uplink transmissions may not cause a PAPR issue, so the configured resource muting pattern may be sparse, and may be based on or may reuse a phase tracking reference signal (PTRS) frequency design or pattern. In some examples, the UE may transmit a discrete Fourier transform (DFT) spread OFDM (DFT-s-OFDM) waveform or a CP-OFDM waveform, and the resource muting pattern may mute every other resource element (RE) of an uplink symbol or uplink subband of subband full duplex (SBFD) symbols. The transmitting UE may perform uplink rate matching (e.g., applying a zero power PTRS pattern and inserting the zero power REs after a DFT spread operation, oversampling after a DFT-s-OFDM procedure and doubling a size of an IFFT, or repeating an input sequence to a DFT and doubling a size of the IFFT, power boosting, updating a power control calculation, etc.). In some examples, the network entity may indicate the resource muting pattern to the UE via control signaling (e.g., radio resource control (RRC) and downlink control information (DCI) signaling, or semi-static uplink rate matching and muting patterns, etc.), and uplink muting patterns may be implemented according to one or more rules.

Aspects of the disclosure are initially described in the context of wireless communications systems. Aspects of the disclosure are further illustrated by and described with reference to wireless communications systems, resource muting schemes, transmission schemes, and process flows. Aspects of the disclosure are further illustrated by and described with reference to apparatus diagrams, system diagrams, and flowcharts that relate to uplink resource muting for various waveforms.

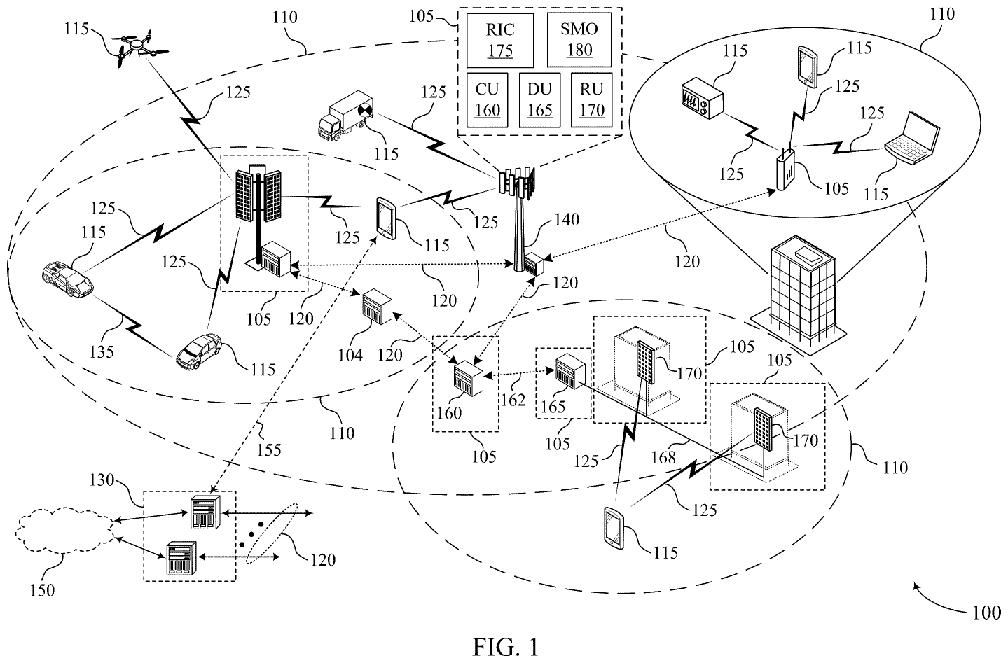

FIG. 1 shows an example of a wireless communications system 100 that supports uplink resource muting for various waveforms in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein provide for resource muting pattens that minimize the need for adjusted transmission parameters or rate matching due to muted resources, uplink transmission procedures and techniques to address rate matching and power control aspects resulting from muted resources, or a combination thereof. For example, a UE 115 may transmit uplink signaling via a CP-OFDM waveform. In such examples, uplink transmissions may not cause a PAPR issue, so the configured resource muting pattern may be sparse, and may be based on or may reuse a PTRS frequency design or pattern. In some examples, the resource muting pattern may mute every other RE of an uplink symbol or uplink subband of SBFD symbols, and the transmitting UE 115 may perform uplink rate matching (e.g., applying a zero power PTRS pattern and inserting the zero power REs after a DFT spread operation, oversampling after a DFT-s-OFDM procedure and doubling a size of an IFFT, or repeating an input sequence to a DFT and doubling a size of the IFFT, power boosting, updating a power control calculation, etc.). In some examples, the network entity may indicate the resource muting pattern to the UE 115 via control signaling (e.g., radio resource control (RRC) and downlink control information (DCI) signaling, or semi-static uplink rate matching and muting patterns, etc.), and uplink muting patterns may be implemented according to one or more rules.

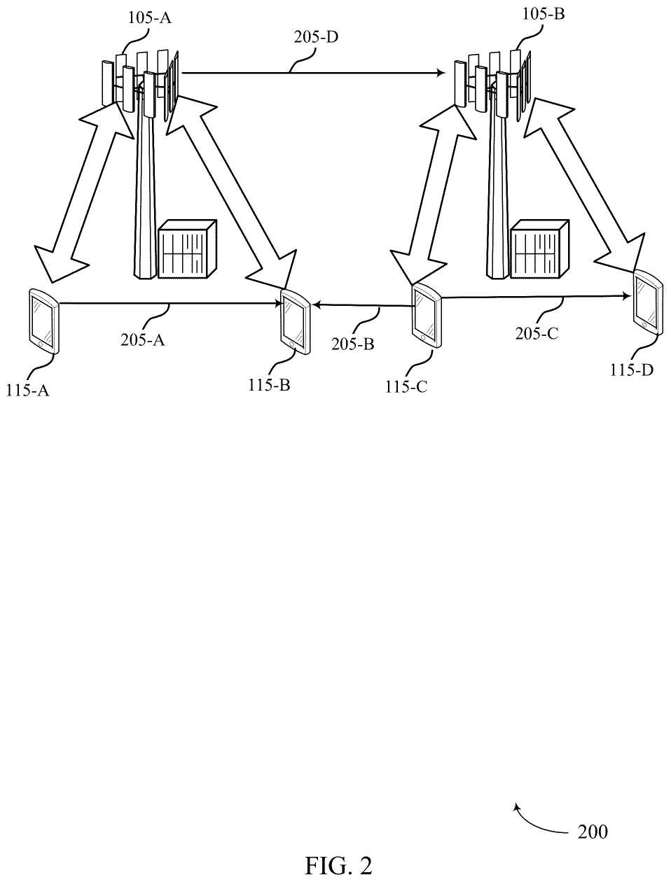

FIG. 2 shows an example of a wireless communications system 200 that supports uplink resource muting for various waveforms in accordance with one or more aspects of the present disclosure. The wireless communications system 200 may implement, or be implemented by, aspects of the wireless communications system 100. For example, the wireless communications system 200 may include one or more network entities 105 (e.g., the network entity 105-a and the network entity 105-b), and one or more UEs 115 (e.g., the UE 115-a the UE 115-b, the UE 115-c, and the UE 115-d), which may be examples of corresponding devices described with reference to FIG. 1. Each network entity 105 may serve one or more UEs (e.g., the network entity 105-a may serve the UE 115-a and the UE 115-b, which may be located in a cell or coverage area corresponding to the network entity 105-a, and the network entity 105-b may serve the UE 115-c and the UE 115-d, which may be located in a cell or coverage area corresponding to the network entity 105-b).

One or more devices in the wireless communications system 200 may support full duplex operations (e.g., SBFD operations in a time domain carrier or intra-band carrier aggregation scenario). For example, the network entity 105-b may support SBFD operations, and may perform simultaneous transmission and reception of uplink signaling (e.g., from the UE 115-c) and downlink signaling (e.g., to the UE 115-d). Uplink and downlink signaling may be scheduled (e.g., with in a component carrier bandwidth) to include downlink resources (e.g., one or more downlink subbands and one or more uplink subbands within the same slot, which may be separated by one or more guard bands). Such SBFD deployments may support increased uplink duty cycles, leading to latency reduction (e.g., because it is possible to transmit uplink signaling in uplink subbands in downlink only slots or flexile slots, which can enable uplink latency savings), and uplink coverage improvements. SBFD deployments may also enhance system capacity, resource utilization, and spectrum efficiency, and may enable flexible and dynamic uplink and downlink resource adaptations according to uplink and downlink traffic in a robust manner. Some SBFD deployments may support SBFD operations at a UE 115. For example, the UE 115-a may simultaneously transmit uplink signaling to the network entity 105-a and receive downlink signaling from the network entity 105-a.

One or more devices operation in a full duplex mode (e.g., a SBFD mode) may generate or experience CLI (e.g., CLI 205). Such CLI may include inter-subband CLI, inter-cell CLI, inter-UE CLI, intra-cell CLI, and inter-gNB CLI (e.g., in-band inter-gNB CLI). CLI 205 (e.g., inter-cell, intra-cell, inter-UE, inter-gNB, etc.) may or may not be inter-subband CLI. For example, the wireless communications system 200 may support fully overlapping full duplex communications (e.g., in which case multiple UEs 115 are performing full duplex communications via the same subbands (e.g., the same uplink subband and the same downlink subbands)). For example, the UE 115-a may transmit uplink signaling, while the UE 115-b is monitoring for downlink signaling. The uplink signaling transmitted by the UE 115-a may result in intra-cell CLI 205-a (e.g., inter-UE, inter-subband CLI), which may impact the UE 115-b when attempting to receive downlink signaling from the network entity 105-a. Similarly, the UE 115-c may transmit uplink signaling to the network entity 105-b, which may result in inter-cell interference 205-b (e.g., inter-subband inter-cell inter-UE CLI) for the UE 115-b, and intra-cell interference 205-c (e.g., inter-SB intra-cell interference) for the UE 115-d.

To mitigate or avoid such CLI 205, wireless communications devices may perform CLI measurements. For instance, the network entity 105-a and the network entity 105-b may perform CLI measurements for CLI mitigation (e.g., gNB-to-gNB co-channel CLI measurements or channel measurements). Such CLI measurements may be performed based on transparent uplink resource muting techniques (e.g., avoiding scheduling on measurement resources), or may be performed based on non-transparent uplink resource muting techniques (e.g., defining uplink resource muting patterns with one or more resource elements (REs) or resource blocks (RBs) muted). For example, if the a wireless device (e.g., the network entity 105-b) is attempting to measure CLI 205 (e.g., the CLI 205-d), but the UE 115-c is transmitting uplink signaling during the CLI measurements, then the CLI measurements may not be accurate, and may therefore result in less effective or ineffective CLI mitigation techniques. Thus, by implementing resource muting as described herein, the network entity 105-b may measure gNB-to-gNB CLI levels, channel measurements, CLI interference covariance matrices, etc. with less interference from uplink signaling.

However, if a UE 115 is sending uplink transmission via one or more uplink resources (e.g., via a physical uplink shared channel (PUSCH)) while muting some uplink resources, some transmission parameters may be ineffective or problematic as a result of the muted resources. For example, transmission power, power control, rate matching, or other transmission parameters for uplink transmissions via the channel may be impacted by muted resources. Without a mechanism to address such transmission parameters, or avoid such impacts to the uplink transmissions via the uplink channel, the resource muting (e.g., which may support effective CLI measurements) may negatively impact other uplink signaling performed via non-muted resources.

Different uplink blanking or muting of resources may be used to measure spatial characteristics of CLI 205 (e.g., gNB-to-gNB CLI) caused by various downlink signaling and to avoid CLI. Uplink resource muting patterns may be different for various downlink channels or signals. For gNB-to-gNB co-channel CLI measurements, the wireless communications system may support muting of REs in uplink slots at a position of part of REs of some signals (e.g., synchronization signal blocks (SSBs), system information blocks (SIBs) such as SIB1, and broadcast PDCCHs from aggressive cells to measure spatial characteristics of downlink broadcast interference, muting of REs in uplink slots at the position of part of REs of unicast PDSCH and PDCCH from aggressive cells to obtain spatial characteristics of unicast PDSCH and PDCCH CLI, muting REs in uplink slots at the position of REs of non-zero power (NZP) channel state information reference signals (CSI-RSs) from aggressive cells to avoid strong CLI.

As described herein, to support CLI measurement and mitigation, a network entity 105 may configure one or more UEs 115 with a resource muting pattern during which the UE 115 may not transmit uplink signaling. For some waveforms, the resource muting pattern may be configured to avoid some impacts on uplink transmission via non-muted resources. For some waveforms, the resource muting pattern may be configured, and the UE 115 may perform uplink transmissions via the channel according to one or more rules, conditions, power control parameters, using zero-power PTRS transmissions, or the like, to mitigate any negative impacts of the resource muting pattern.

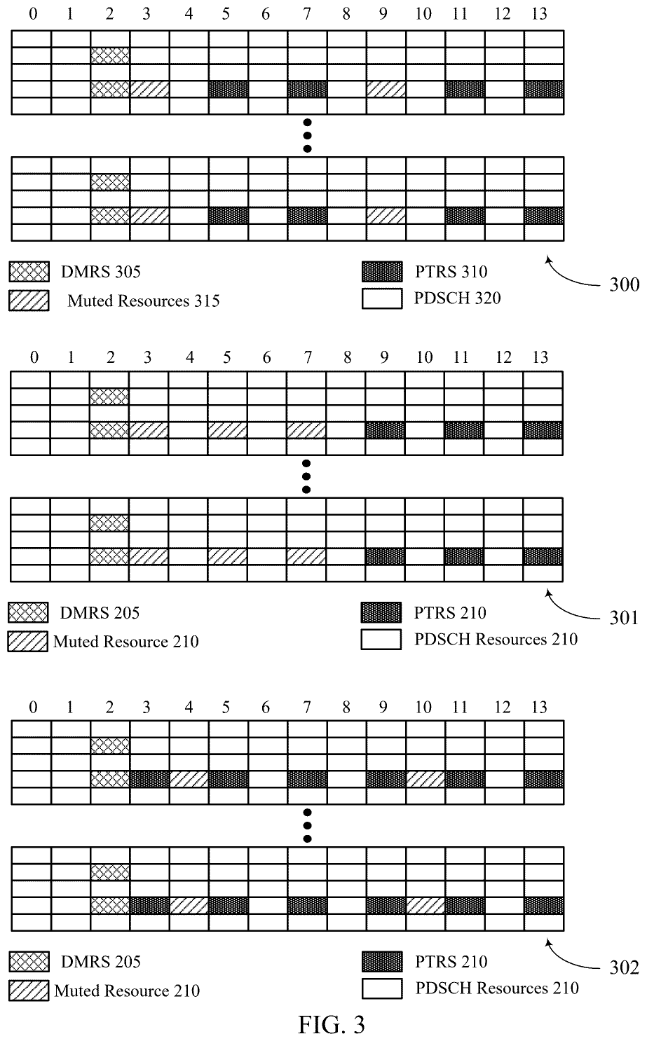

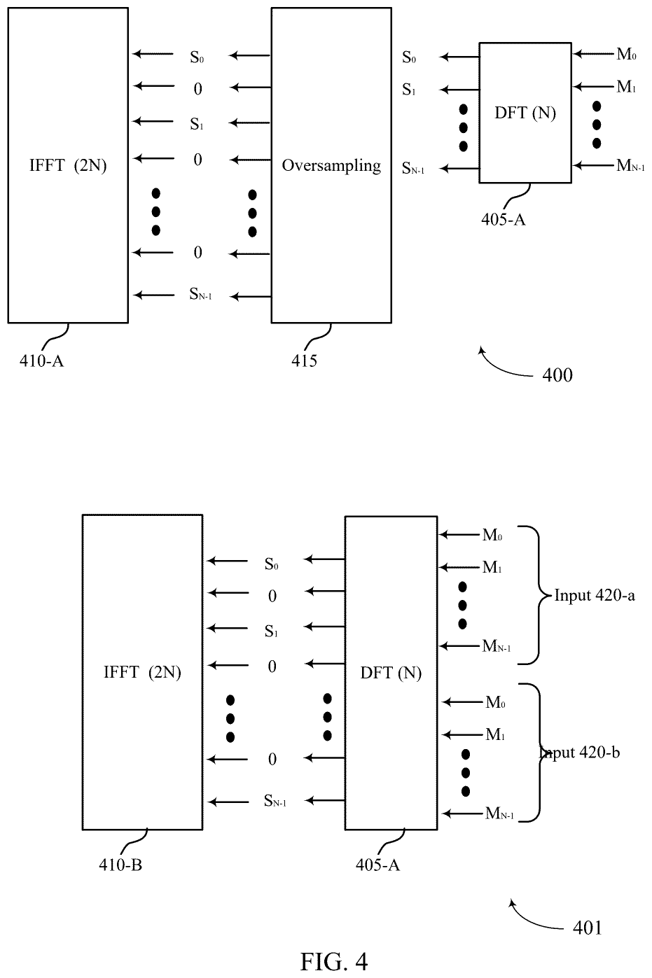

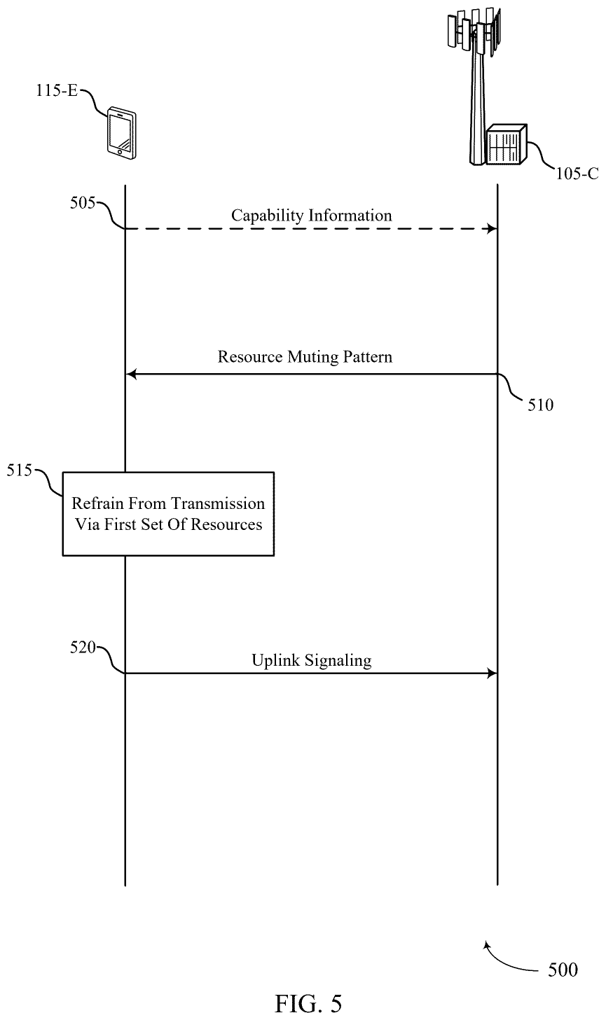

In some examples, as described in greater detail with reference to FIG. 3, a UE 115 may transmit uplink signaling via a cyclic prefix orthogonal frequency division multiplexing (CP-OFDM) waveform. In such examples, uplink transmissions may not cause a PAPR issue, so the configured resource muting pattern may be sparse, and may be based on or may reuse a PTRS frequency design or pattern. In some examples, as described in greater detail with reference to FIG. 4, the resource muting pattern may mute every other RE of an uplink symbol or uplink subband of SBFD symbols, and the transmitting UE may perform uplink rate matching (e.g., applying a zero power PTRS pattern and inserting the zero power REs after a DFT spread operation, oversampling after a DFT-s-OFDM procedure and doubling a size of an IFFT, or repeating an input sequence to a DFT of doubled size and doubling a size of the IFFT, power boosting, updating a power control calculation, etc.). As described in greater detail with reference to FIG. 5, the network entity 105 may indicate the resource muting pattern to the UE 115 via control signaling (e.g., RRC and DCI signaling, or semi-static uplink rate matching and muting patterns, etc.), and uplink muting patterns may be implemented according to one or more rules.

FIG. 3 shows an example of a resource muting scheme 300, a resource muting scheme 301, and a resource muting scheme 302 that support uplink resource muting for various waveforms in accordance with one or more aspects of the present disclosure. The resource muting scheme 300, the resource muting scheme 301, and the resource muting scheme 302, may implement, or be implemented by, aspects of the wireless communications system 100 or the wireless communications system 200. For example, a network entity (e.g., a network entity 105) and a UE (e.g., a UE 115), which may be examples of corresponding devices described with reference to FIGS. 1-2, may communicate according to the resource muting scheme 300, the resource muting scheme 301, the resource muting scheme 302, or a combination thereof.

In some examples, as illustrated with reference to the resource muting scheme 300, the resource muting scheme 301, the resource muting scheme 302, the network entity may configure the UE with a PTRS pattern indicating resources for PTRSs 310. The PTRS pattern may indicate PTRS tones sent according to time and frequency densities specified by the parameters L and K, respectively. For instance, L=1 may indicate that PTRSs are sent on every PUSCH symbol, L=2 may indicate that PTRSs are sent on every two PUSCH symbols, L=4 may indicate that PTRSs are sent on one symbol every 4 PUSCH symbols, K=4 may indicate one PTRS tone is sent every 4 RBs, and K=2 may indicate that one PTRS tone is sent every 2 RBs. The PTRS pattern illustrated with reference to the resource muting scheme 300, the resource muting scheme 301, and the resource muting scheme 302 may correspond to K=2 and L=2 (e.g., although techniques described herein may apply to any PTRS pattern, with any combination of K and L values). Some resources in a given slot may be reserved for control signaling (e.g., symbols 0 and 1), and some resources may be reserved for DMRSs 305 (e.g., symbol 2 and every other frequency resource, such as every other RE or every other tone).

In some examples, uplink signaling by a UE that has been configured with a resource muting pattern (e.g., as described with reference to FIGS. 1-2) may be performed using a waveform such as a CP-OFDM waveform (e.g., or a DFT-s-OFDM waveform). In some examples (e.g., when using a CP-OFDM waveform), PAPR may not be an issue. In such examples, the resource muting pattern may indicate spare uplink resource muting on frequency resources. In some examples, the resource muting pattern may be based on, or may implement aspects of, a PTRS frequency pattern (e.g., a PTRS frequency design). The resource muting pattern may be a PTRS frequency-like uplink resource muting pattern. In some examples, the network entity may transmit first control signaling indicate the PTRS pattern, and second control signaling indicating the muting pattern with reference to the PTRS pattern (e.g., indicating which PTRS resources of the PTRS pattern are to be muted, or an offset from the PTRS pattern for muting, among other examples). In some examples, a single set of control information may indicate a combined PTRS and muting pattern.

The resource muting pattern may indicate REs to be muted according to a first quantity of resources (e.g., tones, REs, RBs, symbols, etc.) to be muted for every set of a second quantity of resources (e.g., RBs, slots, symbols, etc.). For instance, the resource muting pattern may indicate that uplink REs (e.g., frequency resources) are muted on a frequency of K=4 (e.g., one tone is muted every 4 RBs), or K=2 (e.g., one tone is muted every 2 RBs). In some examples, uplink REs may be muted with reference to time. For example, uplink REs may be muted in time as N symbols per slot (e.g., where N is equal to 1, 2, or 0), or N symbols per M slots in time (e.g., where Nis equal to 1, 2, or 0, and M is equal to 1 or 2). In some examples, muted resources in time may be fully overlapping with non-muted resources in time. For instance, the resource muting pattern may indicate L=1 (e.g., the UE is to mute on every PUSCH symbol), L=2 (e.g., the UE is to mute on one symbol every two PUSCH symbols), or L=4 (e.g., the UE is to mute on one symbol every 4 PUSCH symbols).

The resource muting pattern may mute some of indicated PTRS resources. For instance, the muting pattern may mute one uplink RE of every 2 RBs or 4 RBs (e.g., such as a zero power PTRS pattern). Due to such spare uplink muting in frequency, power fluctuation may be decreased (e.g., may be minimal), and power boosting of uplink data and reference signal channels may be avoided.

In some examples, the resource muting pattern may indicate muted resources that partially or completely overlap with PTRS resources. For instance, as illustrated with reference to the resource muting scheme 300, the PTRS pattern may be configured according to K=2 and L=2 (e.g., PTRSs 310 in symbols 3, 5, 7, 9, 11, and 13). Uplink muted symbols may be configured as overlapping with one or more of the PTRS symbols. For example, if the PTRS is configured to transmit every other symbol in time (e.g., PTRSs 310 in symbols 3, 5, 7, 9, 11, and 13), then one or two out of every PTRS symbols per slot can be used for uplink muting (e.g., as a zero power PTRS). The remainder of the PTRS symbols per slot may still be used to transmit PTRSs. For instance, the resource muting pattern may indicate that the UE is to refrain from transmission (e.g., a zero power PTRS) on two PTRS symbols (e.g., the PTRS symbol 3 and the PTRS symbol 9 become muted resources 315). In such examples, the UE may refrain from transmitting via the frequency resources of the PTRSs 310 on 2 of the 6 PTRS resources in each slot (e.g., the frequency resources of the PTRS pattern may be the same as the frequency resources of the resource muting pattern, and the time resources of the resource muting pattern may be a subset of the time resources of the PTRS pattern).

In some examples, as illustrated with reference to the resource muting scheme 301, the PTRS pattern may be configured according to K=2 and L=2 (e.g., PTRSs 310 in symbols 3, 5, 7, 9, 11, and 13). Uplink muted symbols may be configured as overlapping with one or more of the PTRS symbols. For example, if PTRSs are configured to be transmitted every other symbol in time (e.g., PTRSs 310 in symbols 3, 5, 7, 9, 11, and 13), then one portion (e.g., such as the first half as illustrated with reference to the resource muting scheme 301, or the second half) of the PTRS symbols per slot may be used for uplink muting (e.g., as a zero power PTRS). The remainder of the PTRS symbols per slot may still be used to transmit PTRSs 310. For instance, the resource muting pattern may indicate that the UE is to refrain from transmission (e.g., a zero power PTRS) on 3 PTRS symbols (e.g., the PTRS symbols 3, 5, and 7 become muted resources 315). In such examples, the UE may refrain from transmitting via the frequency resources of the PTRSs 310 on a portion (e.g., the first 3 of the 6) PTRS resources in each slot (e.g., the frequency resources of the PTRS pattern may be the same as the frequency resources of the resource muting pattern, and the time resources of the resource muting pattern may be a portion of the time resources of the PTRS pattern).

In some examples, the muted symbols may be configured not to overlap with the PTRS symbols. For example, if the PTRSs 310 are configured for transmission every other symbol in time, as illustrated with reference to the resource muting scheme 302, then one or two (e.g., or K symbols that are not used for PTRS symbols per slot can be used for uplink muting (e.g., as a zero power PTRS). The remainder of the PTRS symbols per slot may still be used to transmit PTRSs. For instance, the resource muting pattern may indicate that the UE is to refrain from transmission (e.g., a zero power PTRS) on symbols that are not allocated for PTRSs 310 (e.g., the muted resources 315 may occur on PDSCH resources 210, such as symbol 4 and symbol 10 of each slot). In such examples, the UE may refrain from transmitting via the same frequency resources of the PTRSs 310 and different resources than the PTRS resources in each slot (e.g., the frequency resources of the PTRS pattern may be the same as the frequency resources of the resource muting pattern, and the time resources of the resource muting pattern may be different than the PTRS pattern).

In some examples, the resource muting pattern may indicate an offset in time resources, frequency resources, or both, from the PTRS resources of the PTRS pattern. For example, if the resource muting pattern indicates an offset in time resources, but no offset (e.g., or an offset of zero resources) from the frequency resources of the PTRS pattern, then the UE may mute the same frequency resources (e.g., tones) as the PTRS resources, but may mute different time resources (e.g., different symbols) than the PTRS symbols. Or, if the resource muting pattern indicates an offset in frequency resources, but no offset (e.g., or an offset of zero resources) from the time resources of the PTRS pattern, then the UE may mute the same time resources (e.g., symbols) as the PTRS resources, but may mute different frequency resources (e.g., different REs or tones) than the PTRS frequency resources. If the resource muting pattern indicates an offset in frequency resources and an offset in time resources, then the muted resources may not overlap in time or frequency with the PTRS resources.

FIG. 4 shows an example of a transmission scheme 400 and a transmission scheme 401 that support uplink resource muting for various waveforms in accordance with one or more aspects of the present disclosure. The transmission scheme 400 and the transmission scheme 401 may implement, or be implemented by, aspects of the wireless communications system 100, the wireless communications system 200, the resource muting scheme 300, the resource muting scheme 301, or the resource muting scheme 302. For example, a UE (e.g., a UE 115) and a network entity (e.g., a network entity 105) may communicate according to the transmission scheme 400 or the transmission scheme 401.

In some examples (e.g., for DFT-s-OFDM or CP-OFDM waveforms), to maintain a PAPR (e.g., despite the resource muting according to the resource muting pattern), the uplink resources may be muted every other RE for uplink symbols or uplink subbands of SBFD symbols. In such examples, the UE may perform rate matching.

For instance, in a muting symbol (e.g., identified by the resource muting pattern), one or more uplink REs may be muted on frequency resources. In some examples, every other RE of a muting symbol may be muted according to a resource muting pattern, such as a comb 2 pattern. In some examples, all REs of a muting symbol may be muted. In some examples, a zero power PTRS pattern may be applied to the frequency resources of a muting symbol. In such examples, a zero power PTRS pattern may be configured by the network, and may indicate the resources (e.g., frequency resources of a muting symbol) during which to refrain from transmission. The UE may insert the zero power REs after performing a DFT spread procedure (e.g., for a set of resources of the muting symbol) and may perform symbol mapping based thereon.

In some examples, uplink resources in time may be muted according to an indicated quantity. For example, the resource muting pattern may indicate that the UE is to perform muting in N symbols per slot in time (e.g., where N can equal 1, 2, or 0). In some examples, the resource muting pattern may indicate that the UE is to perform muting in N symbols per M slots in time (e.g., where N can equal 1, 2, or 0, and M can equal 1 or 2). Values for M and N may be transmission parameters, and may be indicated in the resource muting pattern (e.g., via control signaling) or defined in one or more standards documents. In some examples, muted resources may be fully overlapping (e.g., with other resources, such as PUSCH resources 320). In such examples, the resource muting pattern may indicate L=1 (e.g., the UE is to mute on every PUSCH symbol), L=2 (e.g., the UE is to mute on one symbol every 2 PUSCH symbols), or L=4 (e.g., the UE is to mute on one symbol every 4 PUSCH symbols), among other examples.

In some examples, the UE may transmit capability information indicating that the UE supports one or more resource muting patterns or rate matching procedures (e.g., as described herein). The UE may report its capability to perform such resource muting or rate matching (e.g., rate matching based on the muting) generally (e.g., for all waveforms), or may report waveform specific capabilities (e.g., may report the same capability for CP-OFDM waveforms for uplink muting, or may report separate capabilities for DFT-s-OFDM waveforms and CP-OFDM waveforms).

In some examples (e.g., for DFT-s-OFDM waveforms), to maintain a similar PAPR (e.g., despite uplink resource muting), the UE may perform uplink muting on every other RE on a muted uplink symbol, or uplink subband of an SBFD symbol. In such examples, the UE may perform rate matching. In some examples, as illustrated with reference to the transmission scheme 400, the UE may perform a DFT 405-a (e.g., size N) on a sequence M (e.g., M₀ through M_{N-1} for the DFT of size N). The DFT 405-a of size N may output a sequence s (e.g., s₀ through S_{N-1}). The UE may perform oversampling 415, and may oversample the output sequence s by a factor of 2 (e.g., after DFT-2-OFDM), and may use an IFFT 410-a of size 2N (e.g., the DFT 405-a may have a size N, and the oversampling 415 may result in an output sequence of size 2N, in which case the IFFT 410-a may also have a size of 2N). The muted REs may be represented by the 0 values input into the IFFT 410-a. The UE may transmit (e.g., via non-muted resources) according to an output of the IFFT 410-a.

In some examples, as illustrated with reference to the transmission scheme 401, the UE may repeat an input sequence 420 to a DFT 405-a of size 2N, followed by an IFFT 410-b of size 2N. For example, the UE may generate the input sequence 420-a, including a sequence M (e.g., M₀ through M_{N-1}). The UE may also repeat the input sequence 420-a (e.g., the input sequence 420-b), including the same sequence M (e.g., M₀ through M_{N-1}). Thus, the two sequences M may be input for the DFT 405-a of size 2N. The output of the DFT 405-a may be input into the IFFT 410-b (e.g., also of size 2N). The muted REs may be represented by the 0 values input into the IFFT 410-b. The UE may transmit (e.g., via non-muted resources) according to an output of the IFFT 410-a.

In some examples (e.g., for DFT-s-OFDM waveforms), to maintain a PAPR, the resource muting pattern may indicate that uplink resources are muted every other RE on uplink symbols or uplink subbands of SBFD symbols, in which case the UE may perform rate matching. With resource muting occurring every other RE, the UE may perform power boosting for a muted symbol on uplink data or reference signal transmissions (e.g., for uplink data or reference signals transmitted via unmuted frequency resources during a muted symbol). In some examples, the UE may perform a power boost (e.g., may apply a 3 decibel power boosting) on an EPRE for uplink channel or reference signal transmissions overlapping with the muted symbol. In some examples, the PUSCH power control may be calculated for the transmission occasions across all ports. Then, the UE may apply a scaling factor (e.g., which may be represented as β) depending on a quantity of ports and layers, a transmitted precoding matrix indicator (TPMI), or any combination thereof. In some examples, the UE may calculate a power control according to equation 1:

$$Equation 1$$

$${P}_{PUSCH , b , f , c} ( i , j , {q}_{d} , l ) = min \{ \begin{matrix}{P}_{CMAX , f , c} ( i ) \\ \begin{matrix}{P}_{{O}_{PUSCH} , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , c} ( i ) + {f}_{b , f , c} ( i , l )\end{matrix}\end{matrix} \} .$$

where

$${M}_{R , B , b , f , c}^{PUSCH}$$

(i) is the bandwidth of the PUSCH resource assignment expressed in number of RBs for PUSCH transmission occasion I on active uplink bandwidth part (BWP) b of carrier f of serving cell c and μ is a subcarrier spacing (SCS) configuration. In some examples, Equation 1 may be altered according to techniques described herein (e.g., according to the scaling factor), or a power may be the same in uplink muted symbols and the UE may increase the EPRE by 3 decibels.

In some examples, the UE may not perform any power boosting, but may maintain a same EPRE for uplink data transmission. In such examples, power fluctional may occur, in which case Equation 1 may be adjusted such that M (e.g., a quantity of RBs) are replaced with an effective number of RBs (e.g., a total quantity of RBs minus the muted RBs as indicated by the resource muting pattern). In some examples, the UE may compute an effective quantity of RBs regardless of RB level or RE level muting (e.g., in some examples according to a ceiling or threshold value of the quantity of RBs, which may be indicated as M_{RB}).

FIG. 5 shows an example of a process flow 500 that supports uplink resource muting for various waveforms in accordance with one or more aspects of the present disclosure. The process flow may implement, or be implemented by, aspects of the wireless communications system 100, the wireless communications system 200, the resource muting scheme 300, the resource muting scheme 301, the resource muting scheme 302, the transmission scheme 400, or the transmission scheme 401. For example, a UE (e.g., a UE 115-e) and a network entity (e.g., a network entity 105-c) may communicate according to the process flow 500.

At 510, the UE 115-e may receive (e.g., from the network entity 105-c) control signaling indicating a resource muting pattern. The resource muting pattern may indicate a first set of uplink time and frequency resources for muting uplink transmissions via an uplink channel.

In some examples, the UE 115-e may receive an indication of the uplink muting pattern (e.g., and one or more rate matching or transmission parameters) via a DCI message or uplink rate matching pattern indication (e.g., via a pattern index, which may enable or disable a given uplink muting pattern). For example, the UE 115-e may receive (e.g., at 510) an RRC message indicating multiple candidate resource muting patterns, various candidate rate matching or transmission parameters, or a combination thereof. Subsequently, the UE 115-e may receive (e.g., at 510) a DCI message indicating an index corresponding to one of the candidate resource muting patterns, candidate rate matching or transmission parameters, or a combination thereof. The UE 115-e may refrain from transmission at 515 and perform uplink signaling at 520 according to the resource muting pattern, transmission parameters, rate matching parameters, or combination thereof, according to the indicated index.

In some examples, the UE 115-e may receive an indication of an uplink resource muting pattern or uplink rate matching or transmission parameters via RRC signaling of semi-static uplink rate matching or uplink muting pattern indications with relative periodicities. For example, the UE may receive RRC signaling indicating a semi-static configuration of the resource muting pattern. The semi-static configuration may include transmission parameters such as rate matching parameters, a periodicity for the resource muting pattern, or a combination thereof, among other examples.

At 515, the UE 115-e may refrain from performing at least uplink data channel transmissions via the first set of uplink time and frequency resources via the uplink channel according to the resource muting pattern. At 520, the UE 115-e may transmit uplink signaling (e.g., at least uplink data channel signaling via one or more uplink resources of the uplink channel that do not overlap with the first set of uplink time and frequency resources according to one or more transmission parameters that are based at least in part on the resource muting pattern.

Of the muting pattern is for a first waveform (e.g., CP-OFDM), then the resource muting pattern indicated at 510 may be based on a phase tracking reference signal pattern (e.g., may partially overlap, or be offset from, or may not overlap with PTRS resources, as described in greater detail with reference to FIG. 3), or may mute every other RE of multiple REs (e.g., as described in greater detail with reference to FIGS. 3-4). If the waveform is the first type of waveform or the second type of waveform (e.g., CP-OFDM, or DFT-s-OFDM), then the transmission parameters utilized at 520 may be based on the resource muting pattern, and may include at least one of a transmission power, a zero-power phase tracking reference signal configuration, an IFFT size, an oversampling factor, or any combination thereof.

In some examples (e.g., as described in greater detail with reference to FIG. 3), the resource muting pattern includes an indication of a first quantity of frequency tones for muting in each set of a second quantity of RBs. The muting pattern may include an indication of a first quantity of symbols for muting in each set of a second quantity of slots. The muting pattern may include an indication of a first quantity of PUSCH symbols for muting in each set of a second quantity of PUSCH symbols.

In some examples (e.g., as described in greater detail with reference to FIG. 2), the UE 115-e may receive second control signaling configuring PTRS resources according to a PTRS pattern (e.g., a second set of time and frequency resources for PTRS transmission). In some examples, the first set of uplink time and frequency resources partially overlap with the second set of time and frequency resources, completely overlap with at least a portion of the second set of time and frequency resources, or do not overlap with the second set of time and frequency resources. The first set of time and frequency resources may be zero-power phase tracking reference signal resources of the zero-power phase tracking reference signal configuration. The resource muting pattern may include an indication of a first quantity of symbols that is a subset of frequency resources of the second set of time and frequency resources, where the frequency resources of the first set of time and frequency resources are the same as the frequency resources of the second set of time and frequency resources, and where the time resources of the first set of time and frequency resources include the first quantity of symbols (e.g., as described with reference to the resource muting scheme 300). In some examples, the resource muting pattern includes an indication of a first portion of the frequency resources of the second set of time and frequency resources, where the frequency resources of the first set of time and frequency resources are the same as the frequency resources of the second set of time and frequency resources, and where the time resources of the first set of time and frequency resources include the first portion of the frequency resources of the second set of time and frequency resources (e.g., as described with reference to the resource muting scheme 301). In some examples, the frequency resources of the first set of uplink time and frequency resources overlap with the frequency resources of the second set of uplink time and frequency resources, and the time resources of the first set of uplink time and frequency resources does not overlap with the second set of time and frequency resources.

In some examples, as described with reference to FIG. 3, the resource muting pattern includes an indication of an offset in time from the time resources of the second set of uplink time and frequency resources, an offset in frequency from the frequency resources of the second set of uplink time and frequency resources, or a combination thereof, where the first set of uplink time and frequency resources is shifted from the second set of uplink time and frequency resources according to the offset in time, the offset in frequency, or both.

In some examples, the resource muting pattern includes a comb muting pattern indicating the first set of uplink time and frequency resources including one resource element occurring in one of every two resource elements of a set of resource elements.

In some examples, transmitting the uplink signaling at 520 may be based on rate matching procedures. As described in greater detail with reference to FIG. 4, the UE 115-e may perform a DFT spread procedure corresponding to the REs, and may apply, subsequent not the DFT spread procedure, the zero-power PTRS pattern configuration to each of the first set of uplink time and frequency resources. The UE 115-e may perform an oversampling procedure according to a factor of 2 on an output of the DFT spread procedure, and may perform an IFFT on an output with a double size of IFFT. In some examples, the UE 115-e may duplicate a set of input values for the DFT spread procedure, and may input the set of input values and the duplicate set of input values into the DFT spread procedure, then perform an IFFT on an output of the DFT spread procedure with a doble size of IFFT.

In some examples, the resource muting pattern indicated at 510 may mute every other RE of the multiple REs, and may include an instruction to mute a first quantity of symbols in each slot of multiple slots. In some examples, the one or more transmission parameters may include a power boost value (e.g., 3 decibels, as described with reference to FIG. 4) for the transmission power of the uplink channel overlapping with the first set of uplink time and frequency resources. The UE may calculate a power control for the uplink channel across a set of ports at the UE according to a scaling factor corresponding to the set of ports and a TPMI, where the one or more transmission parameters include the power control, scaling factor, the TPMI, or any combination thereof. In some examples, as described in greater detail with reference to FIG. 4, the UE may calculate the power control across a set of ports at the UE based at least in part on excluding the first set of uplink time and frequency resources of the uplink channel from the calculations.

The resource muting pattern indicated at 510, the transmission at 520, or both, may conform with one or more rules. Such rules may be indicated by the network entity 105-c, or may be preconfigured at the UE 115-e or defined in one or more standards documents. In some examples, for muted uplink REs, muted resources may not be available for virtual resource mapping of uplink data transmission, for uplink control information (UCI), or both. In some examples, muted uplink symbols may not be permitted to overlap with uplink DMRS symbols (e.g. a muting pattern may be valid if it does not overlap with uplink DMRS symbols, or invalid if it does overlap with DMRS symbols). For some waveforms (e.g., for DFT-s-OFDM waveforms), where the UE 115-e mutes every other RE overlapped on PTRS symbols, if a muted RE is overlapped with the PTRS RE, then a rule may define no muting but transmission of the PTRS, or may define muting the RE without transmission of the PTRS.

In some examples, at 505, the UE 115-e may transmit capability information. The capability information may indicate that the UE 115-e is capable of muting uplink resources for multiple waveforms (e.g., for DFT-s-OFDM waveforms and CP-OFDM waveforms, among other examples). In some examples, the capability information may indicate whether the UE 115-e is capable of muting uplink resources for each respective waveform of multiple types of waveforms (e.g., a first capability information for DTS-s-OFDM waveforms, and a second capability information for CP-OFDM waveforms).

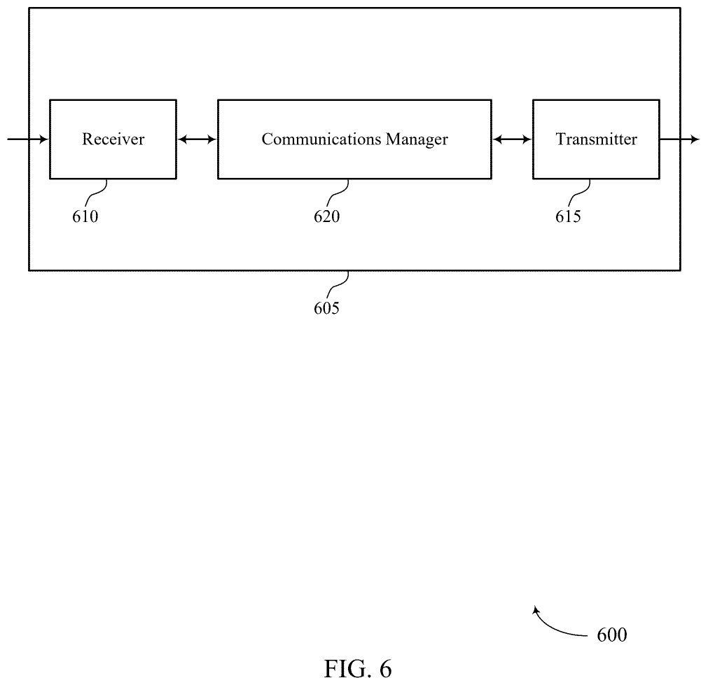

FIG. 6 shows a block diagram 600 of a device 605 that supports uplink resource muting for various waveforms in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink resource muting for various waveforms). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink resource muting for various waveforms). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of uplink resource muting for various waveforms as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling indicating a resource muting pattern indicating a first set of multiple uplink time and frequency resources for muting uplink transmissions via an uplink channel. The communications manager 620 is capable of, configured to, or operable to support a means for refraining from performing at least uplink data channel transmissions via the first set of multiple uplink time and frequency resources via the uplink channel according to the resource muting pattern. The communications manager 620 is capable of, configured to, or operable to support a means for transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for resource muting resulting in improved CLI measurement, decreased interference, improved interference mitigation, improved throughput, decreased system latency, and improved user experience.

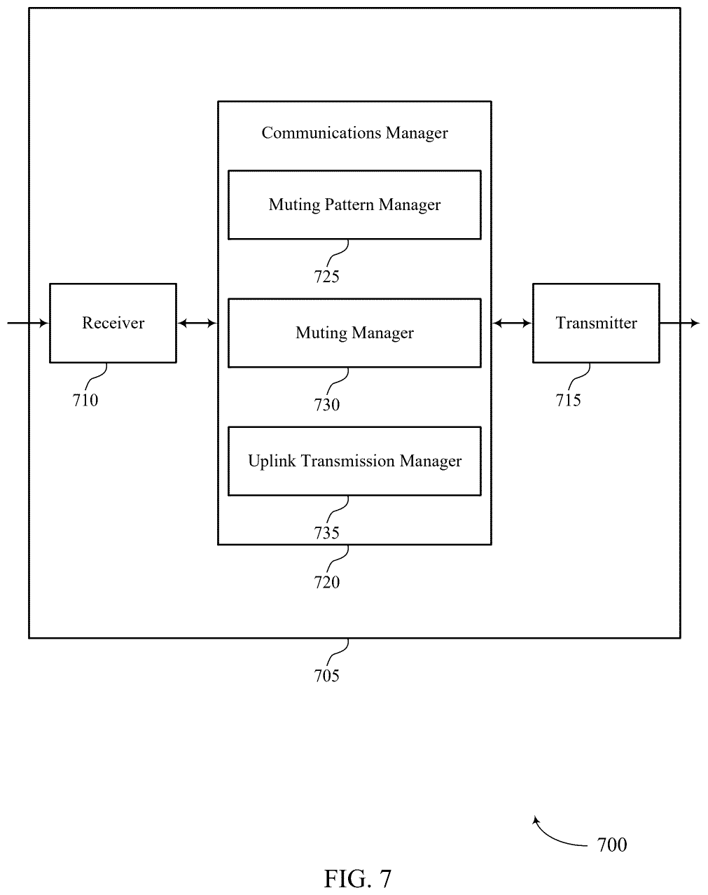

FIG. 7 shows a block diagram 700 of a device 705 that supports uplink resource muting for various waveforms in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink resource muting for various waveforms). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink resource muting for various waveforms). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink resource muting for various waveforms as described herein. For example, the communications manager 720 may include a muting pattern manager 725, a muting manager 730, an uplink transmission manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The muting pattern manager 725 is capable of, configured to, or operable to support a means for receiving control signaling indicating a resource muting pattern indicating a first set of multiple uplink time and frequency resources for muting uplink transmissions via an uplink channel. The muting manager 730 is capable of, configured to, or operable to support a means for refraining from performing at least uplink data channel transmissions via the first set of multiple uplink time and frequency resources via the uplink channel according to the resource muting pattern. The uplink transmission manager 735 is capable of, configured to, or operable to support a means for transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

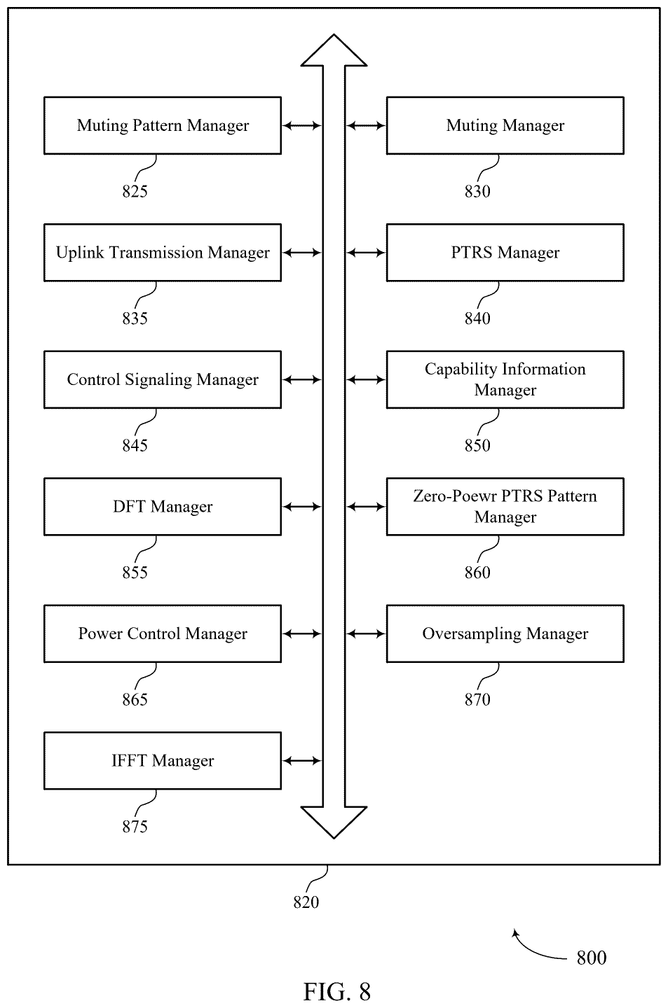

FIG. 8 shows a block diagram 800 of a communications manager 820 that supports uplink resource muting for various waveforms in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink resource muting for various waveforms as described herein. For example, the communications manager 820 may include a muting pattern manager 825, a muting manager 830, an uplink transmission manager 835, an PTRS manager 840, a control signaling manager 845, a capability information manager 850, a DFT manager 855, a zero-power PTRS pattern manager 860, a power control manager 865, an oversampling manager 870, an IFFT manager 875, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The muting pattern manager 825 is capable of, configured to, or operable to support a means for receiving control signaling indicating a resource muting pattern indicating a first set of multiple uplink time and frequency resources for muting uplink transmissions via an uplink channel. The muting manager 830 is capable of, configured to, or operable to support a means for refraining from performing at least uplink data channel transmissions via the first set of multiple uplink time and frequency resources via the uplink channel according to the resource muting pattern. The uplink transmission manager 835 is capable of, configured to, or operable to support a means for transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

In some examples, the resource muting pattern includes an indication of a first quantity of frequency tones for muting in each set of a second quantity of resource blocks of a set of multiple resource blocks. In some examples, refraining from performing at least uplink data channel transmission via the first set of multiple uplink time and frequency resources includes refraining from transmitting via the indicated quantity of frequency tones in each set of the second quantity of resource blocks of the set of multiple resource blocks.

In some examples, the resource muting pattern includes an indication of a first quantity of symbols for muting in each set of a second quantity of slots of a set of multiple slots. In some examples, refraining from performing at least uplink data channel transmission via the first set of multiple uplink time and frequency resources includes refraining from transmitting via the indicated quantity of symbols in each set of the second quantity of slots of the set of multiple slots.

In some examples, the resource muting pattern includes an indication of a first quantity of physical uplink shared channel symbols for muting in each set of a second quantity of physical uplink shared channel symbols. In some examples, refraining from performing at least uplink data channel transmission via the first set of multiple uplink time and frequency resources includes refraining from transmitting via the indicated first quantity of physical uplink shared channel symbols in each set of the second quantity of physical uplink shared channel symbols.

In some examples, the PTRS manager 840 is capable of, configured to, or operable to support a means for receiving second control signaling indicating a second set of multiple time and frequency resources for phase tracking reference signal transmission, where the first set of multiple uplink time and frequency resources partially overlap with the second set of multiple time and frequency resources, completely overlap with at least a portion of the second set of multiple time and frequency resources, or do not overlap with the second set of multiple time and frequency resources, where the first set of multiple time and frequency resources include zero-power phase tracking reference signal resources of the zero-power phase tracking reference signal configuration.

In some examples, the resource muting pattern includes an indication of a first quantity of symbols including a subset of frequency resources of the second set of multiple time and frequency resources, where the frequency resources of the first set of multiple time and frequency resources are the same as the frequency resources of the second set of multiple time and frequency resources, and where the time resources of the first set of multiple time and frequency resources include the first quantity of symbols. In some examples, refraining from at least uplink data channel transmission via the first set of multiple uplink time and frequency resources includes refraining from transmitting via the indicated first quantity of symbols.

In some examples, the resource muting pattern includes an indication of a first portion of the frequency resources of the second set of multiple time and frequency resources, where the frequency resources of the first set of multiple time and frequency resources are the same as the frequency resources of the second set of multiple time and frequency resources, and where the time resources of the first set of multiple time and frequency resources include the first portion of the frequency resources of the second set of multiple time and frequency resources. In some examples, refraining from at least uplink data channel transmission via the first set of multiple uplink time and frequency resources includes refraining from transmitting via the indicated first portion of the second set of multiple time and frequency resources.

In some examples, the frequency resources of the first set of multiple uplink time and frequency resources overlap with the frequency resources of the second set of multiple uplink time and frequency resources. In some examples, the time resources of the first set of multiple uplink time and frequency resources do not overlap with the second set of multiple time and frequency resources.

In some examples, the resource muting pattern includes an indication of an offset in time from the time resources of the second set of multiple uplink time and frequency resources, an offset in frequency from the frequency resources of the second set of multiple uplink time and frequency resources, or a combination thereof. In some examples, the first set of multiple uplink time and frequency resources is shifted from the second set of multiple uplink time and frequency resources according to the offset in time, the offset in frequency, or both.

In some examples, the resource muting pattern includes a comb muting pattern indicating the first set of multiple uplink time and frequency resources including one resource element occurring in one of every two resource elements of a set of multiple resource elements. In some examples, refraining from performing at least uplink data channel transmission via the first set of multiple uplink time and frequency resources includes refraining from transmitting via the indicated one in every two resource elements.

In some examples, the DFT manager 855 is capable of, configured to, or operable to support a means for performing a discrete Fourier transform spread procedure corresponding to the set of multiple resource elements. In some examples, the zero-power PTRS pattern manager 860 is capable of, configured to, or operable to support a means for applying, subsequent to the discrete Fourier transform spread procedure, the zero-power phase tracking reference signal pattern configuration to each of the first set of multiple uplink time and frequency resources, where the at least uplink data channel signaling includes a discrete Fourier transform spread orthogonal frequency division multiplexing (DFT-s-OFDM) waveform.

In some examples, the oversampling manager 870 is capable of, configured to, or operable to support a means for performing an oversampling procedure according to a factor of two on an output of the discrete Fourier transform spread procedure. In some examples, the IFFT manager 875 is capable of, configured to, or operable to support a means for performing an inverse fast Fourier transform on an output of the oversampling procedure with a double size of inverse fast Fourier transform, where the inverse fast Fourier transform size is based on the comb muting pattern indicating the first set of multiple uplink time and frequency resources including one resource element occurring in one of every two resource elements of the set of multiple resource elements.

In some examples, the factor of two, the inverse fast Fourier transform size, or both, are included in the one or more transmission parameters.

In some examples, the DFT manager 855 is capable of, configured to, or operable to support a means for duplicating a set of input values for the discrete Fourier transform spread procedure, the set of input values corresponding to the one or more uplink resources. In some examples, the DFT manager 855 is capable of, configured to, or operable to support a means for inputting the set of input values and the duplicate set of input values into the discrete Fourier transform spread procedure. In some examples, the IFFT manager 875 is capable of, configured to, or operable to support a means for performing an inverse fast Fourier transform on an output of the discrete Fourier transform spread procedure with a double size of inverse fast Fourier transform, where the inverse fast Fourier transform size is based on the comb muting pattern indicating the first set of multiple uplink time and frequency resources including one resource element occurring in one of every two resource elements of the set of multiple resource elements.

In some examples, an instruction to duplicate the set of input values, the inverse fast Fourier transform size, or both, are included in the one or more transmission parameters.

In some examples, the resource muting pattern mutes every other resource element of the set of multiple resource elements, and includes an instruction to mute a first quantity of symbols in each slot of a set of multiple slots. In some examples, refraining from performing at least uplink data channel transmission via the first set of multiple uplink time and frequency resources includes refraining from transmitting via the indicated first quantity of symbols in the set of multiple symbols.

In some examples, the one or more transmission parameters include a power boost value for the transmission power of the uplink channel overlapping with the first set of multiple uplink time and frequency resources.

In some examples, the power control manager 865 is capable of, configured to, or operable to support a means for calculating a power control for the uplink channel across a set of ports at the UE according to a scaling factor corresponding to the set of ports and a transmitted precoding matrix indicator, where the one or more transmission parameters include the power control, scaling factor, the transmitted precoding matrix indicator, or any combination thereof, where transmitting the at least uplink data channel signaling includes transmitting via the uplink channels corresponding to the muting pattern, and where the power boost value corresponds to a 3 decibel increase in energy per resource element (EPRE) of the uplink channel.

In some examples, the power control manager 865 is capable of, configured to, or operable to support a means for calculating a power control for the uplink channel across a set of ports at the UE based on excluding the first set of multiple uplink time and frequency resources of the uplink channel, where the one or more transmission parameters include the power control.

In some examples, to support receiving the control signaling, the control signaling manager 845 is capable of, configured to, or operable to support a means for receiving radio resource control signaling indicating a set of multiple candidate resource muting patterns including the resource muting pattern. In some examples, to support receiving the control signaling, the control signaling manager 845 is capable of, configured to, or operable to support a means for receiving a downlink control information message indicating the resource muting pattern and the one or more transmission parameters including one or more rate matching parameters for transmitting the at least uplink data channel signaling.

In some examples, to support receiving the control signaling, the control signaling manager 845 is capable of, configured to, or operable to support a means for receiving radio resource control signaling including a semi-static configuration of the resource muting pattern, the semi-static configuration including the one or more transmission parameters including one or more rate matching parameters for transmitting the at least uplink data channel signaling, a periodicity for the resource muting pattern, or a combination thereof.

In some examples, the first set of multiple uplink time and frequency resources are unavailable for uplink data transmission or uplink control information.

In some examples, the first set of multiple uplink time and frequency resources do not overlap with a third set of multiple time and frequency resources allocated for uplink demodulation reference signals.

In some examples, the PTRS manager 840 is capable of, configured to, or operable to support a means for determining whether to transmit a phase tracking reference signal via a first resource of the first set of multiple uplink time and frequency resources that overlaps with a phase tracking reference signal resource according to one or more rules.

In some examples, the capability information manager 850 is capable of, configured to, or operable to support a means for transmitting capability information indicating that the UE is capable of muting uplink resources for a set of multiple waveforms, where receiving the control signaling indicating the resource muting pattern is based on transmitting the capability information, and where the at least uplink data channel signaling includes one of the set of multiple waveforms.

In some examples, the capability information manager 850 is capable of, configured to, or operable to support a means for transmitting capability information indicating whether the UE is capable of muting uplink resources for each respective waveform of a set of multiple waveforms, where receiving the control signaling indicating the resource muting pattern is based on transmitting the capability information, and where the at least uplink data channel signaling includes one of the set of multiple waveforms.

In some examples, the at least uplink data channel signaling includes a cyclic prefix-orthogonal frequency division multiplexing (CP-OFDM) waveform, or a discrete Fourier transform spread orthogonal frequency division multiplexing (DFT-s-OFDM) waveform.

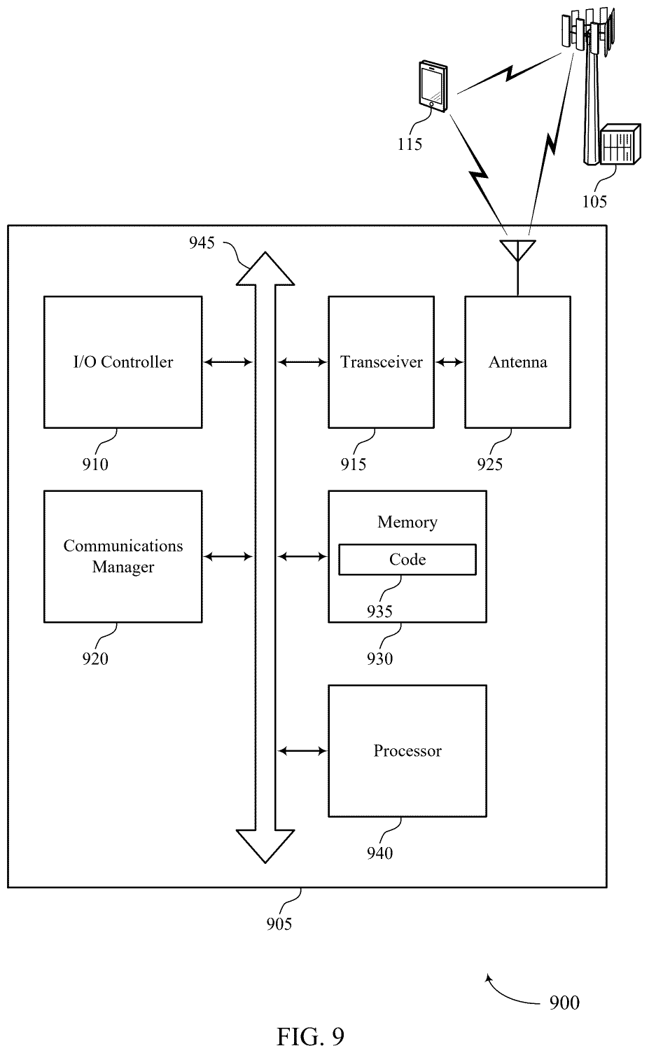

FIG. 9 shows a diagram of a system 900 including a device 905 that supports uplink resource muting for various waveforms in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting uplink resource muting for various waveforms). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling indicating a resource muting pattern indicating a first set of multiple uplink time and frequency resources for muting uplink transmissions via an uplink channel. The communications manager 920 is capable of, configured to, or operable to support a means for refraining from performing at least uplink data channel transmissions via the first set of multiple uplink time and frequency resources via the uplink channel according to the resource muting pattern. The communications manager 920 is capable of, configured to, or operable to support a means for transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

By including or configuring the communications manager 920 in accordance with examples as described herein, the device 905 may support techniques for resource muting resulting in improved CLI measurement, decreased interference, improved interference mitigation, improved throughput, more efficient use of system resources, improved coordination between devices, decreased system latency, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink resource muting for various waveforms as described herein, or the at least one processor 940 and the at least one memory 930 may be otherwise configured to, individually or collectively, perform or support such operations.

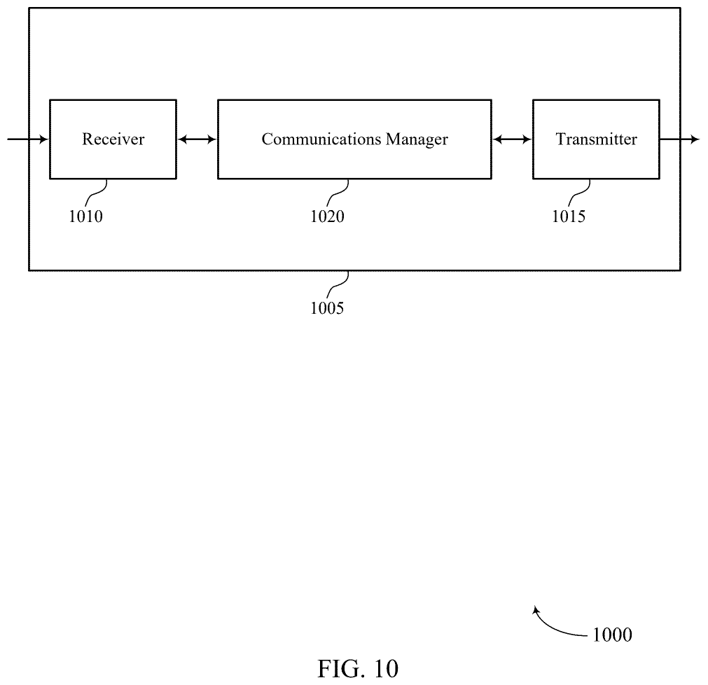

FIG. 10 shows a block diagram 1000 of a device 1005 that supports uplink resource muting for various waveforms in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of uplink resource muting for various waveforms as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting control signaling indicating a resource muting pattern indicating a first set of multiple uplink time and frequency resources for muting, by a UE, uplink transmissions via an uplink channel. The communications manager 1020 is capable of, configured to, or operable to support a means for obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for resource muting resulting in improved CLI measurement, decreased interference, improved interference mitigation, improved throughput, decreased system latency, and improved user experience.

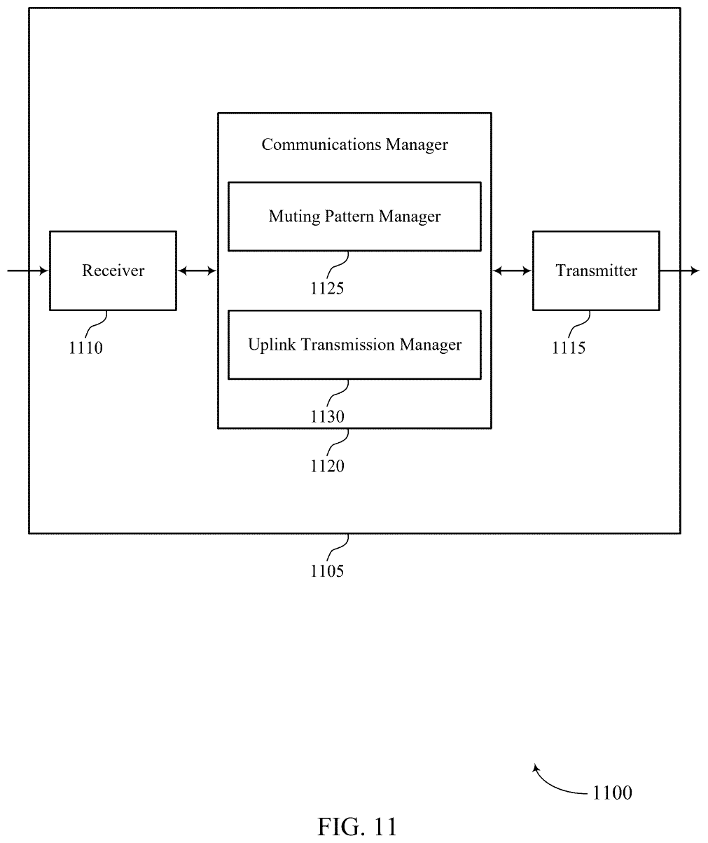

FIG. 11 shows a block diagram 1100 of a device 1105 that supports uplink resource muting for various waveforms in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink resource muting for various waveforms as described herein. For example, the communications manager 1120 may include a muting pattern manager 1125 an uplink transmission manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The muting pattern manager 1125 is capable of, configured to, or operable to support a means for outputting control signaling indicating a resource muting pattern indicating a first set of multiple uplink time and frequency resources for muting, by a UE, uplink transmissions via an uplink channel. The uplink transmission manager 1130 is capable of, configured to, or operable to support a means for obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

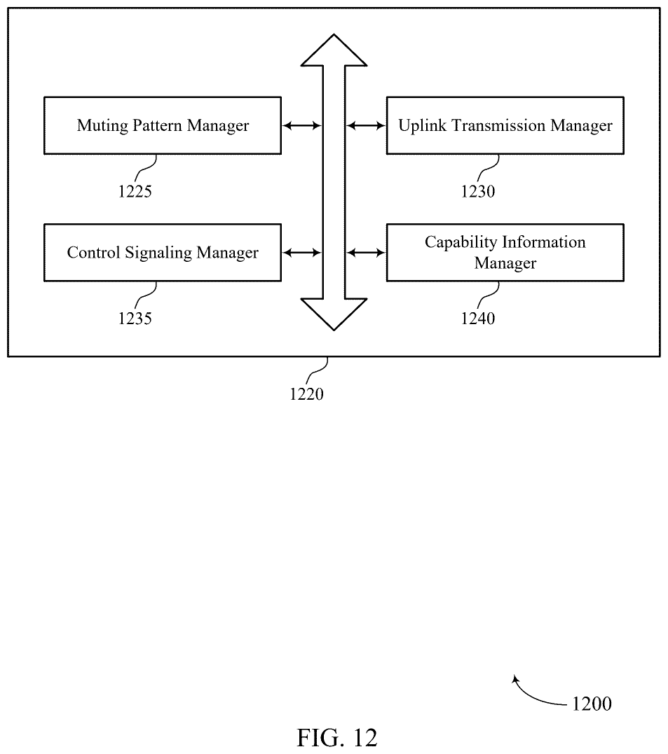

FIG. 12 shows a block diagram 1200 of a communications manager 1220 that supports uplink resource muting for various waveforms in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink resource muting for various waveforms as described herein. For example, the communications manager 1220 may include a muting pattern manager 1225, an uplink transmission manager 1230, a control signaling manager 1235, a capability information manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The muting pattern manager 1225 is capable of, configured to, or operable to support a means for outputting control signaling indicating a resource muting pattern indicating a first set of multiple uplink time and frequency resources for muting, by a UE, uplink transmissions via an uplink channel. The uplink transmission manager 1230 is capable of, configured to, or operable to support a means for obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

In some examples, the resource muting pattern includes an indication of a first quantity of frequency tones for muting in each set of a second quantity of resource blocks of a set of multiple resource blocks.

In some examples, the resource muting pattern includes an indication of a first quantity of symbols for muting in each set of a second quantity of slots of a set of multiple slots.

In some examples, the resource muting pattern includes an indication of a first quantity of physical uplink shared channel symbols for muting in each set of a second quantity of physical uplink shared channel symbols.

In some examples, the control signaling manager 1235 is capable of, configured to, or operable to support a means for outputting second control signaling indicating a second set of multiple time and frequency resources for phase tracking reference signal transmission, where the first set of multiple uplink time and frequency resources partially overlap with the second set of multiple time and frequency resources, completely overlap with at least a portion of the second set of multiple time and frequency resources, or do not overlap with the second set of multiple time and frequency resources, where the first set of multiple time and frequency resources include zero-power phase tracking reference signal resources of the zero-power phase tracking reference signal configuration.

In some examples, the resource muting pattern includes an indication of a first quantity of symbols including a subset of frequency resources of the second set of multiple time and frequency resources. In some examples, the frequency resources of the first set of multiple time and frequency resources are the same as the frequency resources of the second set of multiple time and frequency resources. In some examples, the time resources of the first set of multiple time and frequency resources include the first quantity of symbols.

In some examples, the resource muting pattern includes an indication of a first portion of the frequency resources of the second set of multiple time and frequency resources. In some examples, the frequency resources of the first set of multiple time and frequency resources are the same as the frequency resources of the second set of multiple time and frequency resources. In some examples, the time resources of the first set of multiple time and frequency resources include the first portion of the frequency resources of the second set of multiple time and frequency resources.

In some examples, the frequency resources of the first set of multiple uplink time and frequency resources overlap with the frequency resources of the second set of multiple uplink time and frequency resources. In some examples, the time resources of the first set of multiple uplink time and frequency resources do not overlap with the second set of multiple time and frequency resources.

In some examples, the resource muting pattern includes an indication of an offset in time from the time resources of the second set of multiple uplink time and frequency resources, an offset in frequency from the frequency resources of the second set of multiple uplink time and frequency resources, or a combination thereof. In some examples, the first set of multiple uplink time and frequency resources is shifted from the second set of multiple uplink time and frequency resources according to the offset in time, the offset in frequency, or both.

In some examples, the resource muting pattern includes a comb muting pattern indicating the first set of multiple uplink time and frequency resources including one resource element occurring in one of every two resource elements of a set of multiple resource elements.

In some examples, the resource muting pattern mutes every other resource element of the set of multiple resource elements, and includes an instruction to mute a first quantity of symbols in each slot of a set of multiple slots.

In some examples, the one or more transmission parameters include a power boost value for the transmission power of the uplink channel overlapping with the first set of multiple uplink time and frequency resources.

In some examples, to support outputting the control signaling, the control signaling manager 1235 is capable of, configured to, or operable to support a means for outputting radio resource control signaling indicating a set of multiple candidate resource muting patterns including the resource muting pattern. In some examples, to support outputting the control signaling, the control signaling manager 1235 is capable of, configured to, or operable to support a means for outputting a downlink control information message indicating the resource muting pattern and the one or more transmission parameters including one or more rate matching parameters for outputting the at least uplink data channel signaling.

In some examples, to support outputting the control signaling, the control signaling manager 1235 is capable of, configured to, or operable to support a means for outputting radio resource control signaling including a semi-static configuration of the resource muting pattern, the semi-static configuration including the one or more transmission parameters including one or more rate matching parameters for outputting the at least uplink data channel signaling, a periodicity for the resource muting pattern, or a combination thereof.

In some examples, the first set of multiple uplink time and frequency resources are unavailable for uplink data transmission or uplink control information.

In some examples, the first set of multiple uplink time and frequency resources do not overlap with a third set of multiple time and frequency resources allocated for uplink demodulation reference signals.

In some examples, the capability information manager 1240 is capable of, configured to, or operable to support a means for obtaining capability information indicating that the UE is capable of muting uplink resources for a set of multiple waveforms, where obtaining the control signaling indicating the resource muting pattern is based on obtaining the capability information, and where the at least uplink data channel signaling includes one of the set of multiple waveforms.

In some examples, the capability information manager 1240 is capable of, configured to, or operable to support a means for obtaining capability information indicating whether the UE is capable of muting uplink resources for each respective waveform of a set of multiple waveforms, where outputting the control signaling indicating the resource muting pattern is based on obtaining the capability information, and where the at least uplink data channel signaling includes one of the set of multiple waveforms.

In some examples, the at least uplink data channel signaling includes a cyclic prefix-orthogonal frequency division multiplexing (CP-OFDM) waveform, or a discrete Fourier transform spread orthogonal frequency division multiplexing (DFT-s-OFDM) waveform.

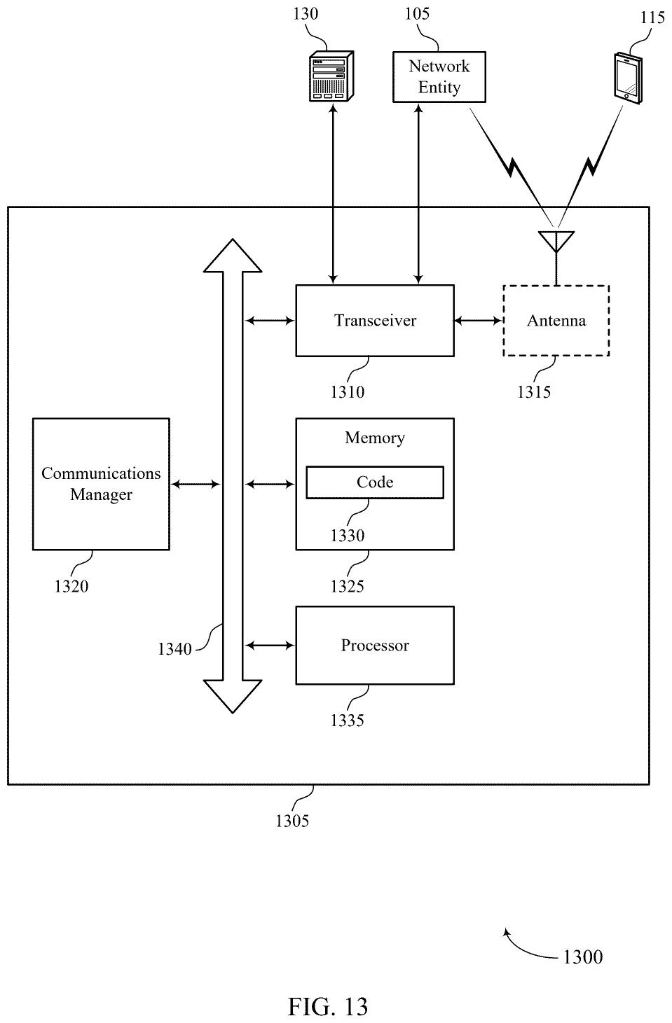

FIG. 13 shows a diagram of a system 1300 including a device 1305 that supports uplink resource muting for various waveforms in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting uplink resource muting for various waveforms). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting control signaling indicating a resource muting pattern indicating a first set of multiple uplink time and frequency resources for muting, by a UE, uplink transmissions via an uplink channel. The communications manager 1320 is capable of, configured to, or operable to support a means for obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor.

By including or configuring the communications manager 1320 in accordance with examples as described herein, the device 1305 may support techniques for resource muting resulting in improved CLI measurement, decreased interference, improved interference mitigation, improved throughput, more efficient use of system resources, improved coordination between devices, decreased system latency, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of uplink resource muting for various waveforms as described herein, or the at least one processor 1335 and the at least one memory 1325 may be otherwise configured to, individually or collectively, perform or support such operations.

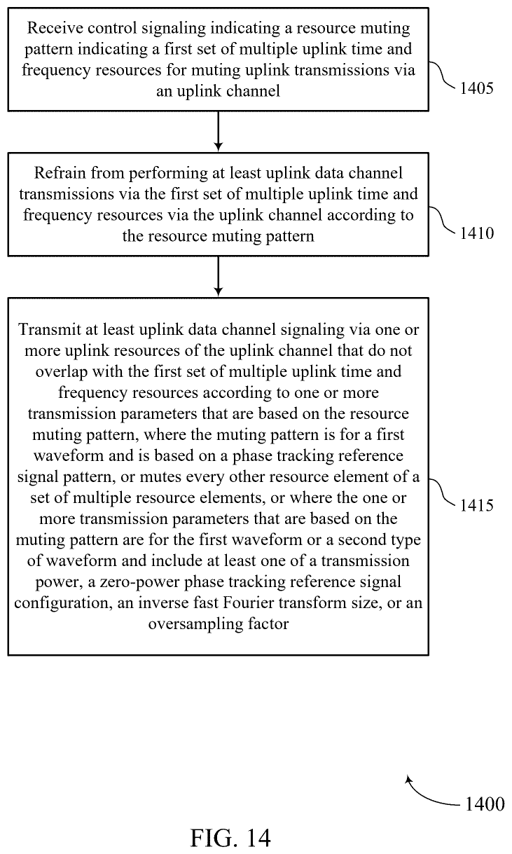

FIG. 14 shows a flowchart illustrating a method 1400 that supports uplink resource muting for various waveforms in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a resource muting pattern indicating a first set of multiple uplink time and frequency resources for muting uplink transmissions via an uplink channel. The operations of 1405 may be performed in accordance with examples as disclosed herein. In some examples, aspects of the operations of 1405 may be performed by a muting pattern manager 825 as described with reference to FIG. 8.

At 1410, the method may include refraining from performing at least uplink data channel transmissions via the first set of multiple uplink time and frequency resources via the uplink channel according to the resource muting pattern. The operations of 1410 may be performed in accordance with examples as disclosed herein. In some examples, aspects of the operations of 1410 may be performed by a muting manager 830 as described with reference to FIG. 8.

At 1415, the method may include transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor. The operations of 1415 may be performed in accordance with examples as disclosed herein. In some examples, aspects of the operations of 1415 may be performed by an uplink transmission manager 835 as described with reference to FIG. 8.

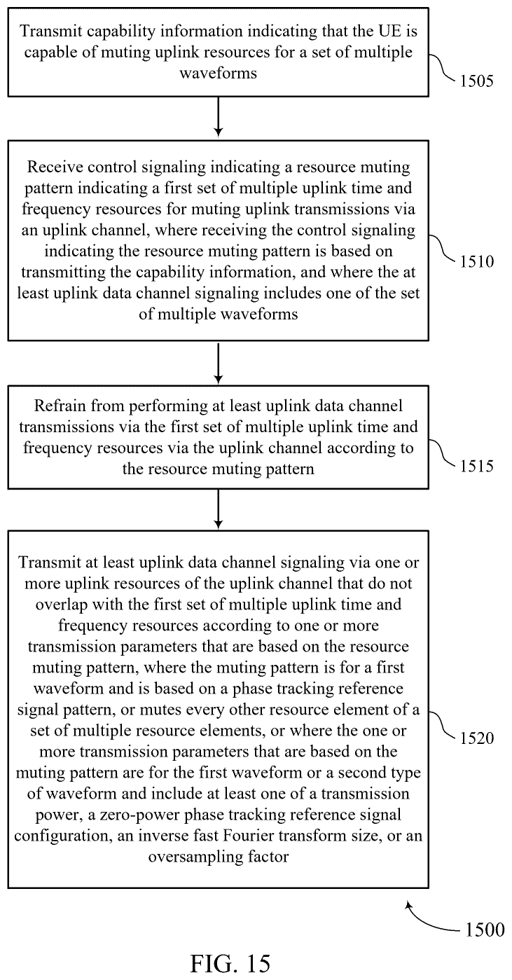

FIG. 15 shows a flowchart illustrating a method 1500 that supports uplink resource muting for various waveforms in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting capability information indicating that the UE is capable of muting uplink resources for a set of multiple waveforms. The operations of 1505 may be performed in accordance with examples as disclosed herein. In some examples, aspects of the operations of 1505 may be performed by a capability information manager 850 as described with reference to FIG. 8.

At 1510, the method may include receiving control signaling indicating a resource muting pattern indicating a first set of multiple uplink time and frequency resources for muting uplink transmissions via an uplink channel, where receiving the control signaling indicating the resource muting pattern is based on transmitting the capability information, and where the at least uplink data channel signaling includes one of the set of multiple waveforms. The operations of 1510 may be performed in accordance with examples as disclosed herein. In some examples, aspects of the operations of 1510 may be performed by a muting pattern manager 825 as described with reference to FIG. 8.

At 1515, the method may include refraining from performing at least uplink data channel transmissions via the first set of multiple uplink time and frequency resources via the uplink channel according to the resource muting pattern. The operations of 1515 may be performed in accordance with examples as disclosed herein. In some examples, aspects of the operations of 1515 may be performed by a muting manager 830 as described with reference to FIG. 8.

At 1520, the method may include transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor. The operations of 1520 may be performed in accordance with examples as disclosed herein. In some examples, aspects of the operations of 1520 may be performed by an uplink transmission manager 835 as described with reference to FIG. 8.

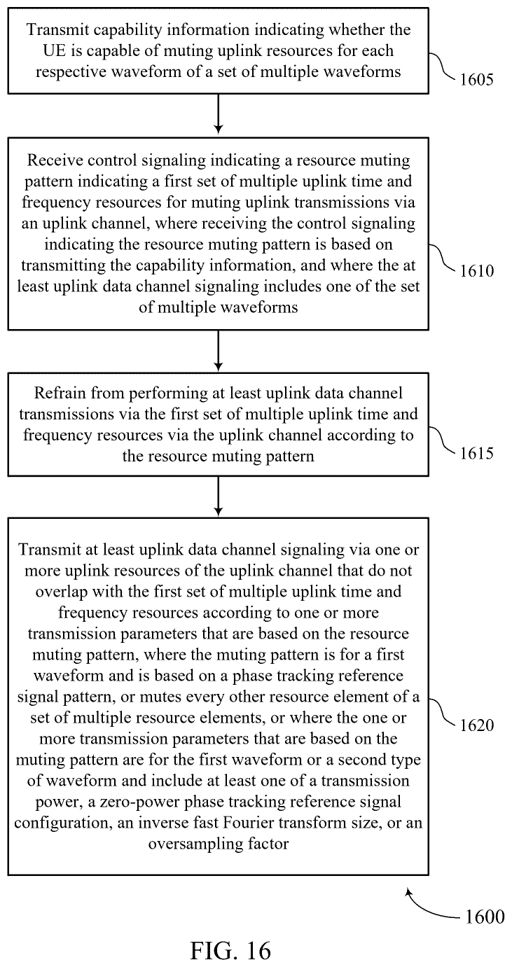

FIG. 16 shows a flowchart illustrating a method 1600 that supports uplink resource muting for various waveforms in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting capability information indicating whether the UE is capable of muting uplink resources for each respective waveform of a set of multiple waveforms. The operations of 1605 may be performed in accordance with examples as disclosed herein. In some examples, aspects of the operations of 1605 may be performed by a capability information manager 850 as described with reference to FIG. 8.

At 1610, the method may include receiving control signaling indicating a resource muting pattern indicating a first set of multiple uplink time and frequency resources for muting uplink transmissions via an uplink channel, where receiving the control signaling indicating the resource muting pattern is based on transmitting the capability information, and where the at least uplink data channel signaling includes one of the set of multiple waveforms. The operations of 1610 may be performed in accordance with examples as disclosed herein. In some examples, aspects of the operations of 1610 may be performed by a muting pattern manager 825 as described with reference to FIG. 8.

At 1615, the method may include refraining from performing at least uplink data channel transmissions via the first set of multiple uplink time and frequency resources via the uplink channel according to the resource muting pattern. The operations of 1615 may be performed in accordance with examples as disclosed herein. In some examples, aspects of the operations of 1615 may be performed by a muting manager 830 as described with reference to FIG. 8.

At 1620, the method may include transmitting at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor. The operations of 1620 may be performed in accordance with examples as disclosed herein. In some examples, aspects of the operations of 1620 may be performed by an uplink transmission manager 835 as described with reference to FIG. 8.

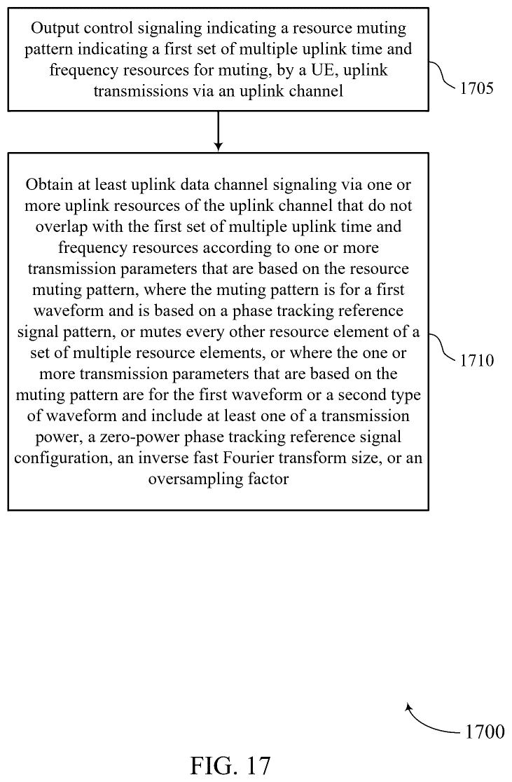

FIG. 17 shows a flowchart illustrating a method 1700 that supports uplink resource muting for various waveforms in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting control signaling indicating a resource muting pattern indicating a first set of multiple uplink time and frequency resources for muting, by a UE, uplink transmissions via an uplink channel. The operations of 1705 may be performed in accordance with examples as disclosed herein. In some examples, aspects of the operations of 1705 may be performed by a muting pattern manager 1225 as described with reference to FIG. 12.

At 1710, the method may include obtaining at least uplink data channel signaling via one or more uplink resources of the uplink channel that do not overlap with the first set of multiple uplink time and frequency resources according to one or more transmission parameters that are based on the resource muting pattern, where the muting pattern is for a first waveform and is based on a phase tracking reference signal pattern, or mutes every other resource element of a set of multiple resource elements, or where the one or more transmission parameters that are based on the muting pattern are for the first waveform or a second type of waveform and include at least one of a transmission power, a zero-power phase tracking reference signal configuration, an inverse fast Fourier transform size, or an oversampling factor. The operations of 1710 may be performed in accordance with examples as disclosed herein. In some examples, aspects of the operations of 1710 may be performed by an uplink transmission manager 1230 as described with reference to FIG. 12.

The following provides an overview of aspects of the present disclosure:

Aspect 1: A method for wireless communications at a UE, comprising: receiving control signaling indicating a resource muting pattern indicating a first plurality of uplink time and frequency resources for muting uplink transmissions via an uplink channel; refraining from performing at least uplink data channel transmissions via the first plurality of uplink time and frequency resources via the uplink channel according to the resource muting pattern; and transmitting at least uplink data channel signaling via one or more uplink resources of the uplink channel that do not overlap with the first plurality of uplink time and frequency resources according to one or more transmission parameters that are based at least in part on the resource muting pattern, wherein the muting pattern is for a first waveform and is based at least in part on a phase tracking reference signal pattern, or mutes every other resource element of a plurality of resource elements, or wherein the one or more transmission parameters that are based at least in part on the muting pattern are for the first waveform or a second type of waveform and comprise at least one of a transmission power, a zero-power phase tracking reference signal configuration, an inverse fast Fourier transform size, or an oversampling factor.

Aspect 2: The method of aspect 1, wherein the resource muting pattern comprises an indication of a first quantity of frequency tones for muting in each set of a second quantity of resource blocks of a plurality of resource blocks, and wherein refraining from performing at least uplink data channel transmission via the first plurality of uplink time and frequency resources comprises refraining from transmitting via the indicated quantity of frequency tones in each set of the second quantity of resource blocks of the plurality of resource blocks.

Aspect 3: The method of any of aspects 1 through 2, wherein the resource muting pattern comprises an indication of a first quantity of symbols for muting in each set of a second quantity of slots of a plurality of slots, and wherein refraining from performing at least uplink data channel transmission via the first plurality of uplink time and frequency resources comprises refraining from transmitting via the indicated quantity of symbols in each set of the second quantity of slots of the plurality of slots.

Aspect 4: The method of any of aspects 1 through 3, wherein the resource muting pattern comprises an indication of a first quantity of physical uplink shared channel symbols for muting in each set of a second quantity of physical uplink shared channel symbols, and wherein refraining from performing at least uplink data channel transmission via the first plurality of uplink time and frequency resources comprises refraining from transmitting via the indicated first quantity of physical uplink shared channel symbols in each set of the second quantity of physical uplink shared channel symbols.

Aspect 5: The method of any of aspects 1 through 4, further comprising: receiving second control signaling indicating a second plurality of time and frequency resources for phase tracking reference signal transmission, wherein the first plurality of uplink time and frequency resources partially overlap with the second plurality of time and frequency resources, completely overlap with at least a portion of the second plurality of time and frequency resources, or do not overlap with the second plurality of time and frequency resources, wherein the first plurality of time and frequency resources comprise zero-power phase tracking reference signal resources of the zero-power phase tracking reference signal configuration.

Aspect 6: The method of aspect 5, wherein the resource muting pattern comprises an indication of a first quantity of symbols comprising a subset of frequency resources of the second plurality of time and frequency resources, wherein the frequency resources of the first plurality of time and frequency resources are the same as the frequency resources of the second plurality of time and frequency resources, and wherein the time resources of the first plurality of time and frequency resources comprise the first quantity of symbols, and wherein refraining from at least uplink data channel transmission via the first plurality of uplink time and frequency resources comprises refraining from transmitting via the indicated first quantity of symbols.

Aspect 7: The method of any of aspects 5 through 6, wherein the resource muting pattern comprises an indication of a first portion of the frequency resources of the second plurality of time and frequency resources, wherein the frequency resources of the first plurality of time and frequency resources are the same as the frequency resources of the second plurality of time and frequency resources, and wherein the time resources of the first plurality of time and frequency resources comprise the first portion of the frequency resources of the second plurality of time and frequency resources, and wherein refraining from at least uplink data channel transmission via the first plurality of uplink time and frequency resources comprises refraining from transmitting via the indicated first portion of the second plurality of time and frequency resources.

Aspect 8: The method of any of aspects 5 through 7, wherein the frequency resources of the first plurality of uplink time and frequency resources overlap with the frequency resources of the second plurality of uplink time and frequency resources, and the time resources of the first plurality of uplink time and frequency resources do not overlap with the second plurality of time and frequency resources.

Aspect 9: The method of any of aspects 5 through 8, wherein the resource muting pattern comprises an indication of an offset in time from the time resources of the second plurality of uplink time and frequency resources, an offset in frequency from the frequency resources of the second plurality of uplink time and frequency resources, or a combination thereof, the first plurality of uplink time and frequency resources is shifted from the second plurality of uplink time and frequency resources according to the offset in time, the offset in frequency, or both.

Aspect 10: The method of any of aspects 1 through 9, wherein the resource muting pattern comprises a comb muting pattern indicating the first plurality of uplink time and frequency resources comprising one resource element occurring in one of every two resource elements of a plurality of resource elements, and wherein refraining from performing at least uplink data channel transmission via the first plurality of uplink time and frequency resources comprises refraining from transmitting via the indicated one in every two resource elements.

Aspect 11: The method of aspect 10, further comprising: performing a discrete Fourier transform spread procedure corresponding to the plurality of resource elements; and applying, subsequent to the discrete Fourier transform spread procedure, the zero-power phase tracking reference signal pattern configuration to each of the first plurality of uplink time and frequency resources, wherein the at least uplink data channel signaling comprises a discrete Fourier transform spread orthogonal frequency division multiplexing (DFT-s-OFDM) waveform.

Aspect 12: The method of aspect 11, further comprising: performing an oversampling procedure according to a factor of two on an output of the discrete Fourier transform spread procedure; and performing an inverse fast Fourier transform on an output of the oversampling procedure with a double size of inverse fast Fourier transform, wherein the inverse fast Fourier transform size is based at least in part on the comb muting pattern indicating the first plurality of uplink time and frequency resources comprising one resource element occurring in one of every two resource elements of the plurality of resource elements.

Aspect 13: The method of aspect 12, wherein the factor of two, the inverse fast Fourier transform size, or both, are included in the one or more transmission parameters.

Aspect 14: The method of any of aspects 11 through 13, further comprising: duplicating a set of input values for the discrete Fourier transform spread procedure, the set of input values corresponding to the one or more uplink resources; inputting the set of input values and the duplicate set of input values into the discrete Fourier transform spread procedure; and performing an inverse fast Fourier transform on an output of the discrete Fourier transform spread procedure with a double size of inverse fast Fourier transform, wherein the inverse fast Fourier transform size is based at least in part on the comb muting pattern indicating the first plurality of uplink time and frequency resources comprising one resource element occurring in one of every two resource elements of the plurality of resource elements.

Aspect 15: The method of aspect 14, wherein an instruction to duplicate the set of input values, the inverse fast Fourier transform size, or both, are included in the one or more transmission parameters.

Aspect 16: The method of any of aspects 10 through 15, wherein the resource muting pattern mutes every other resource element of the plurality of resource elements, and comprises an instruction to mute a first quantity of symbols in each slot of a plurality of slots, and wherein refraining from performing at least uplink data channel transmission via the first plurality of uplink time and frequency resources comprises refraining from transmitting via the indicated first quantity of symbols in the plurality of symbols.

Aspect 17: The method of any of aspects 1 through 16, wherein the one or more transmission parameters comprise a power boost value for the transmission power of the uplink channel overlapping with the first plurality of uplink time and frequency resources.

Aspect 18: The method of aspect 17, further comprising: calculating a power control for the uplink channel across a set of ports at the UE according to a scaling factor corresponding to the set of ports and a transmitted precoding matrix indicator, wherein the one or more transmission parameters comprise the power control, scaling factor, the transmitted precoding matrix indicator, or any combination thereof, wherein transmitting the at least uplink data channel signaling comprises transmitting via the uplink channels corresponding to the muting pattern, and wherein the power boost value corresponds to a 3 decibel increase in energy per resource element (EPRE) of the uplink channel.

Aspect 19: The method of any of aspects 17 through 18, further comprising: calculating a power control for the uplink channel across a set of ports at the UE based at least in part on excluding the first plurality of uplink time and frequency resources of the uplink channel, wherein the one or more transmission parameters comprise the power control.

Aspect 20: The method of any of aspects 1 through 19, wherein receiving the control signaling comprises: receiving radio resource control signaling indicating a plurality of candidate resource muting patterns comprising the resource muting pattern; and receiving a downlink control information message indicating the resource muting pattern and the one or more transmission parameters comprising one or more rate matching parameters for transmitting the at least uplink data channel signaling.

Aspect 21: The method of any of aspects 1 through 20, wherein receiving the control signaling comprises: receiving radio resource control signaling comprising a semi-static configuration of the resource muting pattern, the semi-static configuration comprising the one or more transmission parameters comprising one or more rate matching parameters for transmitting the at least uplink data channel signaling, a periodicity for the resource muting pattern, or a combination thereof.

Aspect 22: The method of any of aspects 1 through 21, wherein the first plurality of uplink time and frequency resources are unavailable for uplink data transmission or uplink control information.

Aspect 23: The method of any of aspects 1 through 22, wherein the first plurality of uplink time and frequency resources do not overlap with a third plurality of time and frequency resources allocated for uplink demodulation reference signals.

Aspect 24: The method of any of aspects 1 through 23, further comprising: determining whether to transmit a phase tracking reference signal via a first resource of the first plurality of uplink time and frequency resources that overlaps with a phase tracking reference signal resource according to one or more rules.

Aspect 25: The method of any of aspects 1 through 24, further comprising: transmitting capability information indicating that the UE is capable of muting uplink resources for a plurality of waveforms, wherein receiving the control signaling indicating the resource muting pattern is based at least in part on transmitting the capability information, and wherein the at least uplink data channel signaling comprises one of the plurality of waveforms.

Aspect 26: The method of any of aspects 1 through 25, further comprising: transmitting capability information indicating whether the UE is capable of muting uplink resources for each respective waveform of a plurality of waveforms, wherein receiving the control signaling indicating the resource muting pattern is based at least in part on transmitting the capability information, and wherein the at least uplink data channel signaling comprises one of the plurality of waveforms.

Aspect 27: The method of any of aspects 1 through 26, wherein the at least uplink data channel signaling comprises a cyclic prefix-orthogonal frequency division multiplexing (CP-OFDM) waveform, or a discrete Fourier transform spread orthogonal frequency division multiplexing (DFT-s-OFDM) waveform.

Aspect 28: A method for wireless communications at a network entity, comprising: outputting control signaling indicating a resource muting pattern indicating a first plurality of uplink time and frequency resources for muting, by a UE, uplink transmissions via an uplink channel; and obtaining at least uplink data channel signaling via one or more uplink resources of the uplink channel that do not overlap with the first plurality of uplink time and frequency resources according to one or more transmission parameters that are based at least in part on the resource muting pattern, wherein the muting pattern is for a first waveform and is based at least in part on a phase tracking reference signal pattern, or mutes every other resource element of a plurality of resource elements, or wherein the one or more transmission parameters that are based at least in part on the muting pattern are for the first waveform or a second type of waveform and comprise at least one of a transmission power, a zero-power phase tracking reference signal configuration, an inverse fast Fourier transform size, or an oversampling factor.

Aspect 29: The method of aspect 28, wherein the resource muting pattern comprises an indication of a first quantity of frequency tones for muting in each set of a second quantity of resource blocks of a plurality of resource blocks.

Aspect 30: The method of any of aspects 28 through 29, wherein the resource muting pattern comprises an indication of a first quantity of symbols for muting in each set of a second quantity of slots of a plurality of slots.

Aspect 31: The method of any of aspects 28 through 30, wherein the resource muting pattern comprises an indication of a first quantity of physical uplink shared channel symbols for muting in each set of a second quantity of physical uplink shared channel symbols.

Aspect 32: The method of any of aspects 28 through 31, further comprising: outputting second control signaling indicating a second plurality of time and frequency resources for phase tracking reference signal transmission, wherein the first plurality of uplink time and frequency resources partially overlap with the second plurality of time and frequency resources, completely overlap with at least a portion of the second plurality of time and frequency resources, or do not overlap with the second plurality of time and frequency resources, wherein the first plurality of time and frequency resources comprise zero-power phase tracking reference signal resources of the zero-power phase tracking reference signal configuration.

Aspect 33: The method of aspect 32, wherein the resource muting pattern comprises an indication of a first quantity of symbols comprising a subset of frequency resources of the second plurality of time and frequency resources, the frequency resources of the first plurality of time and frequency resources are the same as the frequency resources of the second plurality of time and frequency resources, and the time resources of the first plurality of time and frequency resources comprise the first quantity of symbols.

Aspect 34: The method of any of aspects 32 through 33, wherein the resource muting pattern comprises an indication of a first portion of the frequency resources of the second plurality of time and frequency resources, the frequency resources of the first plurality of time and frequency resources are the same as the frequency resources of the second plurality of time and frequency resources, and the time resources of the first plurality of time and frequency resources comprise the first portion of the frequency resources of the second plurality of time and frequency resources.

Aspect 35: The method of any of aspects 32 through 34, wherein the frequency resources of the first plurality of uplink time and frequency resources overlap with the frequency resources of the second plurality of uplink time and frequency resources, and the time resources of the first plurality of uplink time and frequency resources do not overlap with the second plurality of time and frequency resources.

Aspect 36: The method of any of aspects 32 through 35, wherein the resource muting pattern comprises an indication of an offset in time from the time resources of the second plurality of uplink time and frequency resources, an offset in frequency from the frequency resources of the second plurality of uplink time and frequency resources, or a combination thereof, the first plurality of uplink time and frequency resources is shifted from the second plurality of uplink time and frequency resources according to the offset in time, the offset in frequency, or both.

Aspect 37: The method of any of aspects 28 through 36, wherein the resource muting pattern comprises a comb muting pattern indicating the first plurality of uplink time and frequency resources comprising one resource element occurring in one of every two resource elements of a plurality of resource elements.

Aspect 38: The method of aspect 37, wherein the resource muting pattern mutes every other resource element of the plurality of resource elements, and comprises an instruction to mute a first quantity of symbols in each slot of a plurality of slots.

Aspect 39: The method of any of aspects 28 through 38, wherein the one or more transmission parameters comprise a power boost value for the transmission power of the uplink channel overlapping with the first plurality of uplink time and frequency resources.

Aspect 40: The method of any of aspects 28 through 39, wherein outputting the control signaling comprises: outputting radio resource control signaling indicating a plurality of candidate resource muting patterns comprising the resource muting pattern; and outputting a downlink control information message indicating the resource muting pattern and the one or more transmission parameters comprising one or more rate matching parameters for outputting the at least uplink data channel signaling.

Aspect 41: The method of any of aspects 28 through 40, wherein outputting the control signaling comprises: outputting radio resource control signaling comprising a semi-static configuration of the resource muting pattern, the semi-static configuration comprising the one or more transmission parameters comprising one or more rate matching parameters for outputting the at least uplink data channel signaling, a periodicity for the resource muting pattern, or a combination thereof.

Aspect 42: The method of any of aspects 28 through 41, wherein the first plurality of uplink time and frequency resources are unavailable for uplink data transmission or uplink control information.

Aspect 43: The method of any of aspects 28 through 42, wherein the first plurality of uplink time and frequency resources do not overlap with a third plurality of time and frequency resources allocated for uplink demodulation reference signals.

Aspect 44: The method of any of aspects 28 through 43, further comprising: obtaining capability information indicating that the UE is capable of muting uplink resources for a plurality of waveforms, wherein obtaining the control signaling indicating the resource muting pattern is based at least in part on obtaining the capability information, and wherein the at least uplink data channel signaling comprises one of the plurality of waveforms.

Aspect 45: The method of any of aspects 28 through 44, further comprising: obtaining capability information indicating whether the UE is capable of muting uplink resources for each respective waveform of a plurality of waveforms, wherein outputting the control signaling indicating the resource muting pattern is based at least in part on obtaining the capability information, and wherein the at least uplink data channel signaling comprises one of the plurality of waveforms.

Aspect 46: The method of any of aspects 28 through 45, wherein the at least uplink data channel signaling comprises a cyclic prefix-orthogonal frequency division multiplexing (CP-OFDM) waveform, or a discrete Fourier transform spread orthogonal frequency division multiplexing (DFT-s-OFDM) waveform.

Aspect 47: A UE for wireless communications, comprising one or more memories storing processor-executable code, and one or more processors coupled with the one or more memories and individually or collectively operable to execute the code to cause the UE to perform a method of any of aspects 1 through 27.

Aspect 48: A UE for wireless communications, comprising at least one means for performing a method of any of aspects 1 through 27.

Aspect 49: A non-transitory computer-readable medium storing code for wireless communications, the code comprising instructions executable by one or more processors to perform a method of any of aspects 1 through 27.

Aspect 50: A network entity for wireless communications, comprising one or more memories storing processor-executable code, and one or more processors coupled with the one or more memories and individually or collectively operable to execute the code to cause the network entity to perform a method of any of aspects 28 through 46.

Aspect 51: A network entity for wireless communications, comprising at least one means for performing a method of any of aspects 28 through 46.

Aspect 52: A non-transitory computer-readable medium storing code for wireless communications, the code comprising instructions executable by one or more processors to perform a method of any of aspects 28 through 46.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a resource muting pattern indicating a first plurality of uplink time and frequency resources for muting uplink transmissions via an uplink channel;
refrain from performing at least uplink data channel transmissions via the first plurality of uplink time and frequency resources via the uplink channel according to the resource muting pattern; and
transmit at least uplink data channel signaling via one or more uplink resources of the uplink channel that do not overlap with the first plurality of uplink time and frequency resources according to one or more transmission parameters that are based at least in part on the resource muting pattern,
wherein the resource muting pattern is for a first waveform and mutes every other resource element of a plurality of resource elements,
or
wherein the one or more transmission parameters that are based at least in part on the resource muting pattern are for the first waveform or a second type of waveform and comprise at least one of:
a transmission power,
a zero-power phase tracking reference signal configuration,
an inverse fast Fourier transform size, or
an oversampling factor.

2. The UE of claim 1, wherein:
the resource muting pattern comprises a comb muting pattern indicating the first plurality of uplink time and frequency resources comprising one resource element occurring in one of every two resource elements of a plurality of resource elements, and wherein the one or more processors operable to execute the code to cause the UE to refrain from performing at least uplink data channel are individually or collectively further operable to execute the code to cause the UE to:
refrain from transmitting via the one in every two resource elements.

3. The UE of claim 2, wherein the one or more processors are individually or collectively further operable to execute the code to cause the UE to:
perform a discrete Fourier transform spread procedure corresponding to the plurality of resource elements; and
apply, subsequent to the discrete Fourier transform spread procedure, the zero-power phase tracking reference signal configuration to each of the first plurality of uplink time and frequency resources, wherein the at least uplink data channel signaling comprises a discrete Fourier transform spread orthogonal frequency division multiplexing (DFT-s-OFDM) waveform.

4. The UE of claim 3, wherein the one or more processors are individually or collectively further operable to execute the code to cause the UE to:
perform an oversampling procedure according to a factor of two on an output of the discrete Fourier transform spread procedure; and
perform an inverse fast Fourier transform on an output of the oversampling procedure with a double size of inverse fast Fourier transform, wherein the inverse fast Fourier transform size is based at least in part on the comb muting pattern indicating the first plurality of uplink time and frequency resources comprising one resource element occurring in one of every two resource elements of the plurality of resource elements.

5. The UE of claim 4, wherein the factor of two, the inverse fast Fourier transform size, or both, are included in the one or more transmission parameters.

6. The UE of claim 3, wherein the one or more processors are individually or collectively further operable to execute the code to cause the UE to:
duplicate a set of input values for the discrete Fourier transform spread procedure, the set of input values corresponding to the one or more uplink resources;
input the set of input values and the duplicate set of input values into the discrete Fourier transform spread procedure; and
perform an inverse fast Fourier transform on an output of the discrete Fourier transform spread procedure with a double size of inverse fast Fourier transform, wherein the inverse fast Fourier transform size is based at least in part on the comb muting pattern indicating the first plurality of uplink time and frequency resources comprising one resource element occurring in one of every two resource elements of the plurality of resource elements.

7. The UE of claim 6, wherein an instruction to duplicate the set of input values, the inverse fast Fourier transform size, or both, are included in the one or more transmission parameters.

8. The UE of claim 2, wherein:
the resource muting pattern mutes every other resource element of the plurality of resource elements, and comprises an instruction to mute a first quantity of symbols in each slot of a plurality of slots, and wherein the one or more processors operable to execute the code to cause the UE to refrain from performing at least uplink data channel are individually or collectively further operable to execute the code to cause the UE to:
refrain from transmitting via the first quantity of symbols.

9. The UE of claim 1, wherein the one or more transmission parameters comprise a power boost value for the transmission power of the uplink channel overlapping with the first plurality of uplink time and frequency resources.

10. The UE of claim 9, wherein the one or more processors are individually or collectively further operable to execute the code to cause the UE to:
calculate a power control for the uplink channel across a set of ports at the UE according to a scaling factor corresponding to the set of ports and a transmitted precoding matrix indicator, wherein the one or more transmission parameters comprise the power control, scaling factor, the transmitted precoding matrix indicator, or any combination thereof, wherein the one or more processors operable to execute the code to cause the UE to transmit the at least uplink data channel signaling are individually or collectively further operable to execute the code to cause the UE to transmit via the uplink channel corresponding to the resource muting pattern, and wherein the power boost value corresponds to a 3 decibel increase in energy per resource element (EPRE) of the uplink channel.

11. The UE of claim 9, wherein the one or more processors are individually or collectively further operable to execute the code to cause the UE to:
calculate a power control for the uplink channel across a set of ports at the UE based at least in part on excluding the first plurality of uplink time and frequency resources of the uplink channel, wherein the one or more transmission parameters comprise the power control.

12. The UE of claim 1, wherein, to receive the control signaling, the one or more processors are individually or collectively operable to execute the code to cause the UE to:
receive radio resource control signaling indicating a plurality of candidate resource muting patterns comprising the resource muting pattern; and
receive a downlink control information message indicating the resource muting pattern and the one or more transmission parameters comprising one or more rate matching parameters for transmitting the at least uplink data channel signaling.

13. The UE of claim 1, wherein, to receive the control signaling, the one or more processors are individually or collectively operable to execute the code to cause the UE to:
receive radio resource control signaling comprising a semi-static configuration of the resource muting pattern, the semi-static configuration comprising the one or more transmission parameters comprising one or more rate matching parameters for transmitting the at least uplink data channel signaling, a periodicity for the resource muting pattern, or a combination thereof.

14. The UE of claim 1, wherein:
the first plurality of uplink time and frequency resources are unavailable for uplink data transmission or uplink control information.

15. The UE of claim 1, wherein the first plurality of uplink time and frequency resources do not overlap with a third plurality of time and frequency resources allocated for uplink demodulation reference signals.

16. The UE of claim 1, wherein the one or more processors are individually or collectively further operable to execute the code to cause the UE to:
determine whether to transmit a phase tracking reference signal via a first resource of the first plurality of uplink time and frequency resources that overlaps with a phase tracking reference signal resource according to one or more rules.

17. The UE of claim 1, wherein the one or more processors are individually or collectively further operable to execute the code to cause the UE to:
transmit capability information indicating that the UE is capable of muting uplink resources for a plurality of waveforms, wherein reception of the control signaling indicating the resource muting pattern is based at least in part on transmitting the capability information, and wherein the at least uplink data channel signaling comprises one of the plurality of waveforms.

18. The UE of claim 1, wherein the one or more processors are individually or collectively further operable to execute the code to cause the UE to:
transmit capability information indicating whether the UE is capable of muting uplink resources for each respective waveform of a plurality of waveforms, wherein reception of the control signaling indicating the resource muting pattern is based at least in part on transmitting the capability information, and wherein the at least uplink data channel signaling comprises one of the plurality of waveforms.

19. A network entity, comprising:
one or more memories storing processor-executable code; and
one or more processors coupled with the one or more memories and individually or collectively operable to execute the code to cause the network entity to:
output control signaling indicating a resource muting pattern indicating a first plurality of uplink time and frequency resources for muting, by a user equipment (UE), uplink transmissions via an uplink channel; and
obtain at least uplink data channel signaling via one or more uplink resources of the uplink channel that do not overlap with the first plurality of uplink time and frequency resources according to one or more transmission parameters that are based at least in part on the resource muting pattern,
wherein the resource muting pattern is for a first waveform and mutes every other resource element of a plurality of resource elements,
or
wherein the one or more transmission parameters that are based at least in part on the resource muting pattern are for the first waveform or a second type of waveform and comprise at least one of:
a transmission power,
a zero-power phase tracking reference signal configuration,
an inverse fast Fourier transform size, or
an oversampling factor.

20. A method for wireless communication at a user equipment (UE), comprising:
receiving control signaling indicating a resource muting pattern indicating a first plurality of uplink time and frequency resources for muting uplink transmissions via an uplink channel;
refraining from performing at least uplink data channel transmissions via the first plurality of uplink time and frequency resources via the uplink channel according to the resource muting pattern; and
transmitting at least uplink data channel signaling via one or more uplink resources of the uplink channel that do not overlap with the first plurality of uplink time and frequency resources according to one or more transmission parameters that are based at least in part on the resource muting pattern,
wherein the resource muting pattern is for a first waveform and mutes every other resource element of a plurality of resource elements,
or
wherein the one or more transmission parameters that are based at least in part on the resource muting pattern are for the first waveform or a second type of waveform and comprise at least one of:
a transmission power,
a zero-power phase tracking reference signal configuration,
an inverse fast Fourier transform size, or
an oversampling factor.
